(19) United States
(12) Patent Application Publication
(10) Pub. No.: US 2023/0216162 A1
(43) Pub. Date: Jul. 6, 2023

(54) FEEDTHROUGH SYSTEM, METHOD FOR PRODUCING A FEEDTHROUGH SYSTEM, ELECTROCHEMICAL CELL, AND ELECTROCHEMICAL SYSTEM

(71) Applicant: ElringKlinger AG, Dettingen (DE)

(72) Inventors: Felix HAULER, Filderstadt (DE); Mathias WIDMAIER, Magstadt (DE); Christian BECK, Jettingen-Scheppach (DE)

(73) Assignee: ElringKlinger AG, Dettingen (DE)

(21) Appl. No.: 18/182,542

(22) Filed: Mar. 13, 2023

Related U.S. Application Data
(63) Continuation of application No. PCT/EP2021/074676, filed on Sep. 8, 2021.

(30) Foreign Application Priority Data
Sep. 15, 2020 (DE) 10 2020 211 571.0

(51) Int. Cl. H01M 50/627; H01M 50/148; H01M 50/342

(52) U.S. Cl. CPC H01M 50/627; H01M 50/148; H01M 50/3425

(57) ABSTRACT

In order to provide a feedthrough system which can be produced as easily as possible and has an optimized service life, it is proposed that the feedthrough system comprises a wall component which has one or more feedthrough openings, one or more lines which are guided through the one or more feedthrough openings, and a fastening device, the fastening device connecting the one or more lines to the wall component in one or more connection regions of the feedthrough system.

### RELATED APPLICATION

This application is a continuation of international application No. PCT/EP2021/074676 filed on Sep. 8, 2021, and claims the benefit of German application No. 10 2020 211 571.0 filed on Sep. 15, 2020, which are incorporated herein by reference in their entirety and for all purposes.

### FIELD OF DISCLOSURE

The present invention relates to a feedthrough system for an electrochemical system, for example for an electrochemical cell of an electrochemical system.

Furthermore, the present invention relates to a method for producing a feedthrough system, in particular for producing a feedthrough system according to the invention.

The present invention further relates to an electrochemical cell and an electrochemical system.

### BACKGROUND

An electrochemical cell is known from DE 10 2020 200 063, which comprises a contact element that connects a cell terminal to a connection conductor and that is fixed in a connection region to a cover element of the electrochemical cell by means of a potting element.

A battery cell with a cell housing and an electrode winding arranged within the cell housing is known from DE 10 2012 209 397 A1, wherein the electrode winding is covered, at least in regions, by a pressure-sensitive film sensor.

From DE 10 2017 117 077 A1, a battery cell and a method for measuring the internal pressure in a battery cell are known, wherein the battery cell comprises an interior space in which a battery electrolyte is located and a housing that seals the interior space in a gas-tight manner. The battery cell further includes a gas-tight sealed measuring chamber, in which a pressure sensor is arranged and which is separated from the interior by a deformable membrane.

DE 10 2013 216 076 A1 discloses a battery cell with a cell housing surrounding the battery cell, wherein at least one part of the cell housing is designed to deform in the event of a pressure increase within the cell housing and wherein the battery cell comprises a detection device for detecting a deformation of the at least one part of the cell housing.

Further electrochemical cells are known from DE 10 2017 216 873, DE 10 2017 216 874, DE 10 2017 216 886, and DE 10 2018 200 159.

### SUMMARY OF THE INVENTION

The present invention is based on the object of providing a feedthrough system that is as easy to produce as possible and that has an optimized service life.

This object is achieved by a feedthrough system in accordance with claim 1.

The feedthrough system for an electrochemical system comprises a wall component which has one or more feedthrough openings.

It can be advantageous if the wall component comprises a metallic material or is formed thereof. For example, the wall component comprises aluminum or is formed thereof.

The feedthrough system further comprises one or more lines which are guided through the one or more feedthrough openings, and a fastening device which connects the one or more lines to the wall component in one or more connection regions of the feedthrough system.

It can be favorable if the fastening device fixes a relative position of the one or more lines to the wall component in the one or more connection regions. For example, a non-positive and/or positive and/or material connection between the one or more lines and the wall component is formed in the one or more connection regions.

It can be favorable if the fastening device connects the one or more lines to the wall component in the one or more connecting regions in a fluid-tight manner. The one or more lines are fixed to the wall component in a fluid-tight manner, for example, by the fastening device.

The feedthrough system is suitable, for example, for use in an electrochemical cell, for example a lithium-ion battery and/or a lithium-ion accumulator.

Tightness against fluids can be increased by an increased pressure in an interior of the electrochemical cell relative to the environment.

An electrochemical cell preferably comprises a housing which encloses an interior space in a fluid-tight manner. In this way, chemical reactions which take place in the interior of the electrochemical cell can be protected against various environmental influences. The electrochemical cell preferably forms a component of an electrochemical system, for example a battery module.

In particular, the electrochemical cell is suitable for use in a vehicle.

Within the electrochemical cell there is a risk of overcharging, in which fluid is released in the interior of the electrochemical cell. This leads in particular to an increase in a pressure in the interior of the electrochemical cell. In particular, there is the risk of a self-reinforcing heat development and a overheating of the electrochemical cell or of adjacent electrochemical cells, as a result of which an explosive inflammation can occur (a so-called “thermal runaway.”)

For monitoring a pressure and/or a temperature in the interior of an electrochemical cell and in particular for reducing safety risks in connection with a “thermal runaway,” the electrochemical cell preferably comprises a sensor device.

For example, the wall component is a housing of an electrochemical cell or a part thereof.

In particular, the wall component is a cover element of an electrochemical cell or a part thereof.

Preferably, the one or more lines connect a first element arranged in an interior of the electrochemical cell and a second element arranged in the environment of the electrochemical cell electrically and/or mechanically and/or fluidly.

Preferably, the one or more of the multiple lines are each cables for electrically connecting a first element, which is arranged in the interior of the electrochemical cell, for example a sensor element, to a second element which is arranged outside the interior of the electrochemical cell.

Additionally or alternatively, it can be provided that one or more lines are signal conductors, for example in the form of a pin or a screw. The one or more signal lines are used in particular to conduct a signal from an interior of an electrochemical cell into the environment of the electrochemical cell, or vice versa.

It can be advantageous if the one or more connecting regions each comprise or are formed from a volume surrounded by the feedthrough openings.

In particular, the one, or one or more, of the connecting regions each extend radially inwardly from an edge of a respective one of the feedthrough openings with respect to a central axis of the feedthrough opening.

It can be provided that the one, or one or more, of the multiple connection regions, for example one or more sealing elements, stands out and/or projects past the wall component in the axial direction with respect to the central axis of the respective feedthrough opening.

It can be advantageous if the one or more lines are arranged in the one or more feedthrough openings such that their main directions of extension run at least approximately perpendicular to a main plane of extension of the wall component.

For example, the wall component is part of a wall. In particular, the wall component forming part of a wall is joined to one or more further wall components to form an overall wall. For example, the wall component is welded or cast onto a base body of the wall component as an intermediate element. The feedthrough system and/or the wall component can thus be of modular design.

As an alternative to a modular design of the feedthrough system and/or the wall component, it can be provided that the wall component forms the wall as a whole. For example, as already mentioned, the wall component forms a cover element of an electrochemical cell. For example, the feedthrough system and/or the wall component is non-modular.

Material stresses, for example welding stresses, when joining individual parts of the wall can be avoided by a non-modular design of the feedthrough system and/or the wall component.

It can be advantageous if the one or more lines form a component of a sensor device for monitoring a temperature and/or a pressure in an interior of an electrochemical cell.

The sensor device preferably comprises a sensor element, for example a temperature sensor and/or a pressure sensor, which are in fluid contact with the interior of the electrochemical cell.

For example, the sensor element is in fluid contact with the interior of the electrochemical cell via a sensor opening in the wall component.

It may be favorable if the one or more lines connect at least one sensor element for monitoring a pressure and/or a temperature in an interior of an electrochemical cell to a control and/or regulating device of the sensor device.

Alternatively or additionally, the one or more lines connect at least one sensor element for monitoring a pressure and/or a temperature in an interior of an electrochemical cell to a power source.

Embodiments of the feedthrough system which comprise multiple lines are advantageous in particular when the control and/or regulating device is arranged outside the interior of the electrochemical cell.

It can be advantageous if in each case exactly one line is guided through exactly one feedthrough opening.

Additionally or alternatively, it can be favorable if in each case multiple lines are guided through a single feedthrough opening.

Embodiments of the feedthrough system which comprise exactly one line are advantageous in particular when the control and/or regulating device of the sensor device is arranged in the interior of the electrochemical cell.

Preferably, a press fit is formed between the wall component and the one or more of the lines.

Alternatively, it can be provided that a transition fit is formed between the wall component and the one or more lines.

According to a further alternative, it may be provided that a clearance fit is formed between the wall component and the one or more lines.

The formation of a clearance fit can provide the advantage that a mechanical load on the one or more lines due to friction can be reduced.

After the one or more lines are arranged in the one or more feedthrough openings, a volume formed in the one or more feedthrough openings between edge regions of the wall component and the one or more lines is preferably filled and/or sealed in a fluid-tight manner.

Preferably, the one or more feedthrough openings are at least approximately circular in a cross-section taken parallel to the main plane of extension of the wall component. Alternatively, it can be provided that the one or more feedthrough openings are formed at least approximately with an oval shape in a cross-section taken parallel to the main plane of extension of the wall component.

According to a further alternative, it may be provided that the one or more feedthrough openings are at least approximately rectangular or slot-shaped in a cross-section taken parallel to the main plane of extension of the wall component.

Multiple feedthrough openings can also be provided which have different cross-sectional shapes.

The one or more lines are preferably at least approximately circular in a cross-section taken parallel to the main plane of extension of the wall component. For example, the one or more lines are round cables.

Additionally or alternatively, the one or more lines have at least approximately an oval shape in a cross-section taken parallel to the main plane of extension of the wall component.

For example, the one or more lines are ribbon cables.

Additionally or alternatively, the one or more lines have an at least approximately rectangular shape in a cross-section taken parallel to the main plane of extension of the wall component.

It can be provided that the feedthrough system has multiple lines which have shapes differing from one another in a cross-section taken parallel to the main plane of extension of the wall component.

It can be favorable if the fastening device comprises one or more sealing elements which surround the one, or one or more, of the lines in one or more of the connection regions, in particular radially.

In particular, the one or more sealing elements are formed by pouring a potting material into the respective connecting region.

It can be provided that the one or more sealing elements stand out in an axial direction with respect to a central axis of the respective connection region past an outer surface, for example past an outer side, of the wall component that faces away from the interior of the electrochemical cell.

Preferably, a thickness of the one or more sealing elements is at least about 10% of an average thickness of the wall component.

In particular, the thickness of the one or more sealing elements is at most approximately 200% of an average thickness of the wall component. The thickness of the wall component and/or the average thickness of the wall component are preferably defined perpendicular to the main plane of extension of the wall component.

Alternatively to the provision that the thickness of the one or more sealing elements is greater than the thickness of the wall component, it can be provided that the one or more sealing elements have substantially the same thickness as the wall component or have a smaller thickness than the wall component.

For example, the one or more sealing elements are potting elements.

Additionally or alternatively to the formation of the one or more sealing elements as potting elements, it can be provided that the one or more sealing elements are formed by spraying an injection molding material into the respective connection region.

For example, one or more of the lines are injection-molded onto the wall component. In particular, one or more of the lines are overmolded with the injection molding material.

It can be provided that one or more rivet elements are overmolded. The rivet element is formed, for example, from a metallic material. The one or more rivet elements can form a line in the form of a signal conductor.

Preferably, the one or more rivet elements are overmolded together with a, for example sleeve-shaped, support element, wherein the support element is compressed fluid-tight, for example by a subsequent riveting process.

The one or more sealing elements preferably each receive one or more lines and/or surround one or more of the lines, in each case completely, in a connection region.

In embodiments in which the one or more lines are fastened to the wall component by pouring a potting material or by injecting an injection molding material, it can be advantageous if the wall component has one or more receiving recesses which receive the potting material or the injection molding material.

For example, the one or more receiving recesses are made trough-shaped and/or are formed by stamping the wall component.

Additionally or alternatively, it can be provided that the fastening device has one or more, in particular annular, frame elements which are completely or partially filled with the potting material and/or which surround and/or delimit the respective connection region.

In embodiments in which the fastening device has one or more frame elements, sealing elements formed by filling the frame elements protrude beyond the wall component in particular in the axial direction with respect to a central axis of a line.

Preferably, the one or more frame elements are placed on and/or fixed on a base body of the wall component, on an outer side of the wall component facing away from the interior of the electrochemical cell.

For example, a region surrounded by the respective frame element between the respective frame element and the one or more lines is filled with the potting material. When the potting material is cured, a sealing element is formed, in particular.

It can be favorable if the frame element comprises a polymer material or is formed therefrom.

Preferred polymer materials are thermosetting polymer materials, thermoplastic polymer materials, elastomeric polymer materials, or mixtures thereof.

Preferably, one or more hot-melt materials are used as the material of the frame element.

For example, the frame member comprises or is formed from one or more of the following polymeric materials:

polyolefin, in particular polypropylene and/or polyethylene, polyester, in particular polyethylene terephthalate and/or polybutylene terephthalate, polyamide, polyimide, copolyamide, polyamide elastomer, polyethers, in particular epoxy resins, polyurethane, polyurethane acrylate, polyvinyl chloride, polystyrene, polymethyl methacrylate, acrylic butadiene styrene, synthetic rubber, in particular ethylene propylene diene rubber, polycarbonate, polyether sulfone, polyoxymethylene, polyether ether ketone, polytetrafluoroethylene, silicone, in particular silicone rubber and/or silicone-based elastomer.

As an alternative to embodiments in which the one or more frame elements are formed as separate elements, it can be provided that the one or more frame elements are formed by raised parts in a base body of the wall component.

It can be favorable if the potting material comprises a polymer material or is formed therefrom.

Preferably, the polymer material is selected from one or more of the following materials:
an epoxy resin material;
a phenolic resin material;
an aminoplast material;
a polyurethane material;
a silicone material;
a polyester resin material; and
an ABS resin material.

Alternatively, it can be provided that the potting material is a glass material.

The material of the fastening device, for example the potting material and/or the injection molding material, are preferably diffusion-tight, in particular in a cured state.

In particular, the material of the fastening device, for example the potting material and/or the injection molding material, is chemically resistant.

It can be advantageous if the material of the fastening device, for example the potting material and/or the injection molding material, is resistant in a range of about −20° C. to about 80° C., in particular about −30° C. to about 100° C.

In particular, the material of the fastening device, for example the potting material and/or the injection molding material, is fluid-tight at an internal pressure in an electrochemical cell of up to 10 bar.

By pouring and/or injecting material into the one or more connection regions, the number of necessary components of the feedthrough system can be reduced compared to feedthrough systems with other fixing methods.

It can be advantageous if the potting material comprises one or more fillers. The one or more fillers are preferably inorganic fillers, in particular silicon oxide, carbonate, carbide, for example silicon carbide, nitride, for example metal nitride, metal oxide.

It can be advantageous if a material is selected for the one or more sealing elements which is formed in such a way that a drop of water on a surface of the one or more sealing elements encloses a contact angle with the surface of the respective sealing element of greater than 90°.

The contact angle is determined in particular by the standard DIN 55660 and/or the standard DIN EN 828.

It can be advantageous if the material of the one or more sealing elements is resistant to an electrolyte of the electrochemical cell and/or is electrolyte-repellent. In this way, a creeping of electrolytes along boundary surfaces can be prevented.

In particular, in this way a service life of the electrochemical cell can be lengthened.

For example, the material of the one or more sealing elements has a repelling interaction with the electrolyte of the electrochemical cell.

It can be advantageous if the one, or one or more, of the lines have one or more adhesion promoter structures. The one or more adhesion promoter structures are, for example, a sheathing and/or a coating.

It may be favorable if the respective adhesion promoter structure comprises or is formed from a polymer material which is chemically and/or physically compatible with a material of the fastening device.

In this way, a permanent connection between the one or more lines and the wall component can be formed. In particular, the polymer material of the adhesion promoter structure(s) is chemically and/or physically compatible with a material of the wall component.

Alternatively or in addition to a coating and/or sheathing, it can be provided that the one or more lines are subjected to a surface treatment and/or have a treated surface, in particular before fixing by the fastening device.

Preferably, cleaning of the components is carried out before the potting process, in particular plasma cleaning and/or cleaning with isopropanol.

Additionally or alternatively, an adhesion promoter structure can be formed by roughening the one or more lines, for example by sandblasting the one or more lines.

Additionally or alternatively to the provision that the one, or one or more, of the lines have one or more adhesion promoter structures, it can be provided that the feedthrough system comprises one or more adhesion promoter structures which are arranged on a base body of the wall component or are formed by the wall component.

For example, the one or more adhesion promoter structures are formed by a surface treatment and/or coating of the base body of the wall component.

For example, an adhesion promoter can be used as the material for the coating.

It can be provided that an adhesion of the material of the fastening device to the wall component is increased by a (further) surface treatment. As a surface treatment, cleaning of the wall component, for example plasma cleaning and/or cleaning with isopropanol, is preferred.

Alternatively or additionally, one or more adhesion promoter structures in the form of one or more recesses, for example pocket-shaped recesses and/or grooves, may be formed in the wall component.

For example, adhesion promoter structures can be formed by laser treatment and/or by stamping the wall component.

By stamping, for example, recesses can be made in the wall component and/or existing webs can be subsequently pressed down, for example stamped down. The recesses can be T-shaped, for example.

Additionally or alternatively, a contact surface is increased by roughening a surface of the wall component, for example by sandblasting the wall component. A resulting surface preferably forms an adhesion promoter structure.

It can be advantageous if the fastening device has a protective coating. The protective coating is, for example, arranged on and/or applied to an outer surface of the fastening device.

Preferably, the protective coating comprises an oxide or a parylene material or is formed from an oxide or a parylene material.

As oxide, aluminum oxide (Al₂O₃) is preferred.

In particular, a protective function and a sealing function of the fastening device can be separated from one another by the protective coating. For example, a chemically less resistant material can be used as a potting material or as an injection molding material, and the chemical resistance of this material can be increased by the protective coating.

For example, the material is applied to outer surfaces of a resulting sealing element after a pouring of a potting material into the one or more connection regions or after injection of an injection molding material into the one or more connection regions.

In addition or alternatively to the injection and/or casting of the one or more lines, it can be provided that the one, or one or more, of the lines in one or more of the connection regions are fixed to the wall component by welding.

Alternatively or additionally, one or more of the lines, for example in the form of one or more cables and/or one or more signal conductors, can be fastened to the wall component by hot caulking.

It can be advantageous if the one, or one or more, of the lines are mechanically compressed and/or pressed in one or more of the connection regions, in particular by shaping the wall component or by shrinkage on the wall component or by shrinkage on one or more insert elements of the fastening device.

For example, a material of the wall component contracts during the production of the feedthrough system, so that the one or more lines are compressed and/or pressed together.

Alternatively, a material of the one or more insert elements contracts in the direction of the one or more lines, such that the one or more lines are pressed together.

Preferably, a material of the wall component or a material of the one or more insert elements is selected such that the one or more lines are compressed and/or pressed, but a flow of current and/or fluid flow through the one or more lines can still take place.

In embodiments in which the one or more lines are mechanically compressed and/or pressed by shaping of the wall component in one or more of the connection regions, the wall component part is formed, for example, by flanging.

In embodiments in which the fastening device comprises one or more insert elements, it can be advantageous for the one or more insert elements to be formed by a potting process of a casting material which becomes smaller when cooling due to a change in volume during crystallization and/or when there is thermal expansion during the potting process.

For example, the one or more insert elements comprise or are formed from a glass material or aluminum.

It can be favorable if the one, or one or more, of the lines have multiple parts, wherein in each case a first line component is electrically and/or fluidly connected to a second line component by a connecting element.

In particular, the respective connecting element is received by the fastening device or forms a part of the fastening device. For example, the respective connecting element is embedded in a potting material of the one or more sealing elements.

It can be advantageous if the wall component comprises one or more stabilizing elements in which the one, or one or more, of the feedthrough openings are arranged, wherein the one or more stabilizing elements each have one or more raised parts.

Preferably, the one or more stabilizing elements are formed integrally with a base body of the wall component. For example, the one or more stabilizing elements and the base body of the wall component are made from the same sheet.

Alternatively, it can be provided that the one or more stabilizing elements and the base body of the wall component are separate components and/or are produced separately from one another. For example, the one or more stabilizing elements are connected to one another in a materially bonded and/or force-locking and/or positively-locking manner.

Preferably, the one or more raised parts extend away from a base body of the respective stabilizing element, in particular along a direction that runs perpendicular to a main plane of extension of the wall component.

In particular, the one or more raised parts extend between one or more reprocessed regions of the respective stabilization element, away from the base body of the respective stabilization element.

It can be advantageous if the one or more raised parts are formed by the one or more reprocessed regions.

It can be favorable if the one or more stabilizing elements comprise or are formed from a metallic material, for example aluminum.

It can be advantageous if the one or more reprocessed regions are web-shaped.

It can be favorable if the one or more raised parts are at least approximately triangular in a cross-section taken parallel to the main plane of extension of the wall component.

Additionally or alternatively, it can be provided that the one or more raised parts are at least approximately rectangular or oval in a cross-section taken parallel to the main plane of extension of the wall component.

The one or more reprocessed regions are preferably formed and/or processed in a stamping process and/or a milling process.

It can be provided that the one or more stabilizing elements each have a bulge around the respective feedthrough opening and/or around a sensor opening.

For example, one or more bulges are formed by reprocessed regions, which are delimited by arched and/or curved walls of the one or more raised parts.

For example, one or more of the reprocessed regions each form a circumferential frame which, in particular, forms an edge of the, or of one or more of, the connection region(s).

The one or more stabilizing elements preferably serve as a receptacle and/or a basin for potting material.

Potting material can preferably be received in a potting process in and/or from the one or more reprocessed regions. The one or more reprocessed regions form, for example, part of a potting material guide channel along which the potting material flows in a flowable state during the production of the feedthrough system.

The one or more raised portions and the one or more reprocessed portions preferably form an increased surface area of the wall component in the one or more connecting regions. In particular, adhesion of the potting material to the wall component is optimized by the one or more raised parts and the one or more reprocessed regions.

According to a preferred embodiment, the wall component comprises exactly one stabilizing element, which in particular forms the connection region.

The one or more raised parts preferably form rigidifying regions.

Preferably, potting material flows around the one or more raised parts.

It may be advantageous if the one or more reprocessed regions have a reduced material thickness compared to the one or more raised parts.

Preferably, a thickness of the stabilizing element in the region of the one or more reprocessed regions is approximately 80% or less, in particular approximately 60% or less, for example approximately 40% or less, of an average thickness of the wall component outside the respective connection region and/or an average thickness of the one or more raised parts.

Preferably, the thickness of the stabilizing element in the region of the one or more reprocessed regions is approximately 1% or more, in particular approximately 2% or more, for example approximately 5% or more, of an average thickness of the wall component outside the respective connection region and/or an average thickness of the one or more raised parts.

The thickness of the elements mentioned is preferably defined perpendicular to the main plane of extension of the wall component.

Preferably, the one or more raised parts are completely surrounded by the one or more reprocessed regions in a plane parallel to the main plane of extension of the wall component.

In particular, the one or more reprocessed regions form recesses in the respective stabilizing element.

A surface structuring and/or a contouring of the wall component is preferably formed by the one or more raised parts and the one or more reprocessed regions.

It can be advantageous if the fastening device comprises one or more support elements for supporting and/or positioning the one, or one or more, of the lines. Preferably, the one or more support elements are disk-shaped and/or sleeve-shaped.

The one or more support elements are preferably separately produced and/or separately handleable components.

For example, one or more of the support elements protrude in the axial direction on an outer side of the wall component facing away from the interior and/or on an inner side of the wall component facing the interior in relation to a central axis of a line. In particular, the one or more support elements form an overhang over the one or more feedthrough openings in the axial direction with respect to a central axis of the respective line.

According to a preferred embodiment, two support elements are arranged one inside the other, one or more lines being received in the radially inner supporting element. The two support elements protrude and/or stand out in particular on opposite sides of the wall component.

Preferably, a feedthrough channel is formed by the one or more support elements.

The one or more sealing elements and the one and the multiple support elements are preferably different components from each other. For example, the one or more support elements can be cast in the one or more connection regions by means of the potting material and can thus each be received by a sealing element formed by curing the potting material.

In addition or as an alternative to one or more separate support elements, it can be provided that the wall component has one or more raised parts in a direction running perpendicular to the main plane of extension of the wall component, which in particular form part of a positive-fit connection with one or more lines. The raised parts preferably form support elements. This realization of the support elements can be advantageous in particular for a pressure sensor.

The one or more support elements are used in particular for thermal and/or electrical insulation. Additionally or alternatively, the one or more support elements serve to center the line(s) received therein and/or to position the respective line(s).

In particular in the case of lines which are at least approximately circular in a cross-section taken parallel to the main plane of extension of the wall component, it can be advantageous if a force fit is formed between the one or more support elements and the one or more lines and/or the wall component. This can be advantageous in particular when forming a transition fit between the one or more lines and the wall component.

Alternatively, the one or more support elements can also be fixed to the wall component by injection and/or spraying on the wall component.

Alternatively, it can be provided that the one or more support elements are fixed to the wall component by means of clamps; for example, a support element is respectively clamped in a respective feedthrough opening.

The one or more support elements can, for example, form relief elements for strain relief.

It can be favorable if the fastening device comprises one or more relief elements by means of which the one, or one or more, of the lines are affixed to one side of the wall component, for example to an outer side facing away from an interior, by material bonding, for example by casting, and/or in a positive-locking manner, for example by forming a relief element as a clamp or sealing bead, and/or in a force-locking manner.

It can be advantageous if the one or more relief elements are separate components which are fixed by material bonding, for example by adhesive bonding and/or welding, on the wall component and, for example, fix one or more lines with a positive-locking connection and/or with a force-locking connection.

As an alternative to a materially bonded fixing, one or more relief elements are each laid around one or more lines and are clipped onto the wall component and/or are clipped with the wall component.

Additionally or alternatively, it can be provided that the one or more lines is formed by a, in particular cord-shaped, relief element which, for example, is pressed against the respective line in a flowable state during manufacture. The relief element is, for example, a sealing bead.

Additionally or alternatively, one or more relief elements can be formed by recesses in the wall component, in which the one or more lines are fixed by a material connection, for example in a potting process.

The one or more recesses in the wall component can be a component of the receiving recesses which form a part of the connection region.

Alternatively, it can be provided that the recesses in the wall component forming relief elements are spatially separated from the one or more receiving recesses that form part of a connection region.

It can be provided that one or more frame elements are arranged and/or fixed on one side, for example an outer side facing away from the interior of the housing, of the wall component, on a base body of the wall component, which elements are filled with potting material.

For example, one or more lines are pressed into and/or immersed in the potting material before a curing of the potting material.

The invention also relates to a method for producing a feedthrough system, in particular a feedthrough system according to the invention.

In this respect, the object of the invention is to provide a method by means of which a feedthrough system having an optimized service life can be produced as simply as possible.

According to the invention, this object is solved by a method according to the independent method claim.

According to the method, a wall component is provided which has one or more feedthrough openings. One or more lines are guided through the one or more feedthrough openings.

The one or more lines are fixed on the wall component in one or more connection regions by a fastening device.

In particular, the one or more lines are fixed to the wall component in such a way that a relative position of the one or more lines is fixed relative to the wall component, in particular in a fluid-tight manner.

One or more of the features mentioned in connection with the feedthrough system according to the invention and/or one or more of the advantages mentioned in connection with the feedthrough system according to the invention apply equally in particular to the method according to the invention.

It can be favorable if one or more raised parts are formed by stamping or milling of a stabilization element.

It can be advantageous if the one or more lines are fixed in a two-stage casting process relative to the wall component and/or on the wall component and/or in the one or more feedthrough openings.

Preferably, the one or more lines are fixed with a fixing material relative to the wall component and/or in the one or more feedthrough openings.

In particular, for example after the fixing material has been partially or completely dried and/or cured, a potting filler material is subsequently poured and/or filled into the one or more connecting regions.

For example, the fixing material is dried and/or cured until it has a viscosity of about 10¹⁰ mPa·s or more at 25° C.

In particular, just enough fixing material is used to form a fixing of the one or more lines to the wall component and/or in the one or more feedthrough openings.

The fixing material and/or the potting filler material are preferably potting materials.

It may be favorable if a potting material, for example the potting filler material, flows around one or more raised parts of a stabilizing element of the wall component.

The present invention further relates to an electrochemical cell.

The object of the invention in this respect is to provide an electrochemical cell which has an optimized service life.

This object is achieved according to the invention by an electrochemical cell according to the independent claim directed to an electrochemical cell.

The electrochemical cell comprises one or more feedthrough systems according to the invention.

One or more of the features mentioned in connection with the feedthrough system according to the invention and/or one or more of the advantages mentioned in connection with the feedthrough system according to the invention apply equally in particular to the electrochemical cell according to the invention.

In particular, part of a housing of the electrochemical cell which surrounds an interior of the electrochemical cell forms a wall component of at least one of the one or more feedthrough systems.

For example, a cover element of the housing of the electrochemical cell forms a wall component of at least one of the one or more feedthrough systems, in particular all wall components of all the feedthrough systems.

It can be provided that one or more feedthrough systems form a part of a housing, for example the cover element, of the electrochemical cell.

Alternatively, it can be provided that one or more of the feedthrough systems form a part of the cover element. For example, one or more wall components of one or more feedthrough systems are cast into a base body of the cover element of the electrochemical cell and/or are cast thereon.

It can be advantageous if the one, or one or more, of the feedthrough systems form a component of a terminal feedthrough in the region of which a connecting conductor of the electrochemical cell is fixed to the cover element of the electrochemical cell.

Additionally or alternatively, it can be provided that the one, or one or more, of the feedthrough systems comprise or form a burst element which is arranged and/or designed such that it breaks when a critical pressure and/or a critical temperature in the interior of the electrochemical cell is exceeded.

The feedthrough system, which comprises or forms a burst element, is preferably welded to a base body of the cover element.

Additionally or alternatively, it can be provided that the one, or one or more, of the feedthrough systems comprise or form a fuse. The fuse preferably melts when a critical electrical current is exceeded and thus interrupts a flow of current from the electrochemical element (cell winding) to a cell terminal.

It can be advantageous if the respective line is destroyed or damaged when the burst element breaks and/or the fuse is tripped, in particular in such a way that a current, for example an information current, is interrupted.

It can be provided that the one, or one or more, of the feedthrough systems comprise or form an electrolyte filling opening for filling and/or removing electrolyte from the interior of the electrochemical cell.

In this way the feedthrough system may perform multiple functions.

The present invention further comprises an electrochemical system comprising one or more electrochemical cells according to the invention.

The object of the invention is to provide an electrochemical system which has an optimized service life.

This object is achieved according to the invention by an electrochemical system according to the independent claim directed at an electrochemical system.

One or more of the features described in connection with the electrochemical cell according to the invention and/or one or more of the advantages described in connection with the electrochemical cell according to the invention apply equally in particular to the electrochemical system.

The following description and the drawings of embodiments relate to further features and/or advantages of the invention.

### BRIEF DESCRIPTION OF THE DRAWINGS

FIG. 1 shows a schematic plan view of a wall component of an embodiment of a feedthrough system in a state before assembly of the feedthrough system, the wall component having multiple recessed regions in which the wall component has a reduced wall thickness compared to non-recessed regions, wherein the wall component is at least approximately rectangular in a plan view;

FIG. 2 shows a schematic perspective view of a wall component of a further embodiment of a feedthrough system in a state before assembly of the feedthrough system, the wall component being at least approximately circular in a plan view;

FIG. 3 shows a schematic plan view of the feedthrough system from FIG. 2 in an assembled state, wherein a line in the form of a cable is guided through a feedthrough opening which is arranged in a recessed region of the wall component and is connected to the wall component in a connection region of the feedthrough system by means of a fastening device;

FIG. 4 shows a view corresponding to FIG. 3 of the feedthrough system from FIGS. 2 and 3 during production of the feedthrough system in a state before the line is guided through the feedthrough opening, wherein a frame element is applied to the wall component, around all recessed regions of the wall component and spaced apart from these recessed regions;

FIG. 5 shows a schematic sectional view of the feedthrough system from FIGS. 1 to 4 in a ready-to-use state, wherein a region surrounded by the frame element is filled with a potting material and a sealing element is thus formed;

FIG. 6 shows a schematic sectional view of a further embodiment of a feedthrough system, in which the wall component is substantially flat and/or planar with the exception of the openings;

FIG. 7 shows a schematic sectional view of a further embodiment of a feedthrough system in which no separate frame element is provided;

FIG. 8 shows a schematic sectional view of a further embodiment of a feedthrough system in which the cable and edge regions of the wall component are surrounded in a plug-like manner by a potting material in the connecting region;

FIG. 9 shows a schematic sectional view of multiple cables of a feedthrough system, a single cable being guided in each case through a single feedthrough opening of the feedthrough system;

FIG. 10 shows a schematic sectional illustration of multiple cables of a feedthrough system, the multiple cables being guided together through a single feedthrough opening of the feedthrough system;

FIG. 11 shows a schematic sectional view of a cable of a feedthrough system which forms a clearance fit with the wall component in the region of the feedthrough opening;

FIG. 12 shows a schematic sectional view of a cable of a feedthrough system which forms a transition fit with the wall component in the region of the feedthrough opening;

FIG. 13 shows a schematic sectional view of a cable of a feedthrough system which forms a press fit with the wall component in the region of the feedthrough opening;

FIG. 14 shows a schematic sectional view of a further embodiment of a feedthrough system in which the cable is clamped in the feedthrough opening by pressing;

FIG. 15 shows a schematic sectional view of a further embodiment of a feedthrough system in which the cable is fixed in the feedthrough opening by material expansion of an insert element in the course of a shrinkage;

FIG. 16 shows a schematic sectional view of a further embodiment of a feedthrough system in which the cable is radially surrounded by a support element in the region of the feedthrough opening;

FIG. 17 shows a schematic sectional view of a further embodiment of a feedthrough system in which a support element radially surrounds a connecting element for connecting two cable components;

FIG. 18 shows a schematic sectional view of a further embodiment of a feedthrough system in which two support elements are arranged in interlocking fashion, wherein an inner support element of the two support elements receives the cable and wherein an outer support element of the two support elements surrounds the inner support element from the outside;

FIG. 19 shows a schematic sectional view of a further embodiment of a feedthrough system in which two support elements are provided, one of the two support elements having an at least approximately T-shaped cross-section and receiving a connecting element for connecting two cable components, and a further one of the two support elements being at least approximately disk-shaped;

FIG. 20 shows a schematic sectional view of a further embodiment of a feedthrough system in which a relief element is received in the feedthrough opening, wherein the relief element receives and/or radially surrounds the cable, wherein the relief element is fixed on the wall component by material bonding, for example by injection molding or casting, and/or with a force-locking fit and/or a positive-locking, for example by clamping;

FIG. 21 shows a schematic sectional view of a further embodiment of a feedthrough system in which a relief element is formed in that the cable is received in a receiving recess of the wall component, in a potting material;

FIG. 22 shows a schematic sectional view of a further embodiment of a feedthrough system in which a relief element is formed in that the cable is received in a potting material in a region surrounded by a frame element;

FIG. 23 shows a schematic sectional view of a further embodiment of a feedthrough system in which a separately handleable relief element is provided which partially surrounds the cable on its outer surface and which is connected to the wall component by material bonding, for example by gluing and/or welding;

FIG. 24 shows a schematic sectional view of a further embodiment of a feedthrough system in which a separately handleable relief element is provided which partially surrounds the cable on its outer surface and which is connected to the wall component in a positive-locking and/or force-locking manner, for example by a clip connection;

FIG. 25 shows a view corresponding to FIG. 2 of a further embodiment of a feedthrough system according to which the wall component comprises a stabilizing element which has a surface structuring in the form of one or more raised parts between reprocessed regions;

FIG. 26 shows a schematic perspective view of an electrochemical cell comprising a feedthrough system substantially corresponding to the embodiment shown in FIG. 25, the wall component forming a cover element of the electrochemical cell; and

FIG. 27 shows an enlarged sectional view through the feedthrough system of FIG. 26, a sensor device from FIG. 26 being shown only in part.

The same or functionally equivalent elements are provided with the same reference signs in all figures.

### DETAILED DESCRIPTION OF THE DRAWINGS

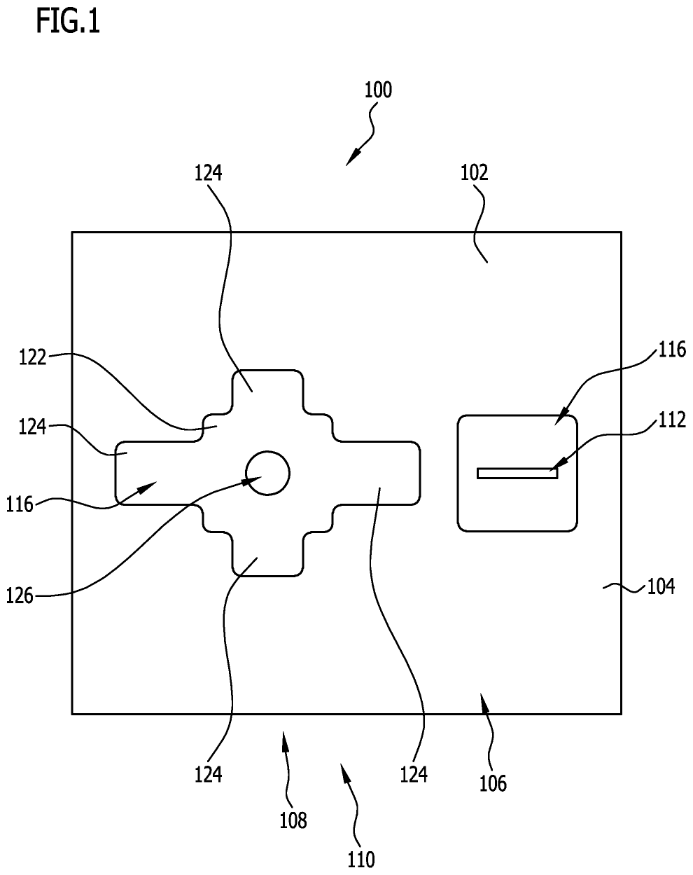

FIG. 1 shows a wall component 102 of an embodiment of a feedthrough system 100 not shown as a whole in the drawing.

In the present case, the wall component 102 is a cover element 104. The cover element 104 forms, for example, a part of a housing 106 of an electrochemical cell 108 not shown as a whole in the drawing. The electrochemical plate 108 preferably forms a part of an electrochemical system 110, also not shown as a whole in the drawings.

The electrochemical system 110 is particularly suitable for use in a vehicle.

For example, the electrochemical cell 108 is a lithium-ion battery and/or a lithium-ion accumulator.

Alternatively to the provision that the wall component 102 forms the entire cover element 104, it can be provided that the wall component 102 forms only a part of a cover element 104. For example, the wall component 102 is placed into a recess provided for this purpose in the cover element 104 and in particular is fixed in a fluid-tight manner. Fluid-tight fixing is carried out, for example, by welding or casting. A modular design is thus possible.

It can be advantageous if the wall component 102 comprises a metallic material or is formed therefrom. Aluminum is suitable, for example, as the metallic material.

The housing 106 of the electrochemical cell 108 preferably further comprises a further, for example cup-shaped, housing component which, together with the cover element 104, surrounds an interior of the electrochemical cell 108 (not shown).

In the present case, the wall component 102 comprises a feedthrough opening 112 which is used to guide a line 115 through the wall component 102.

For a use of the wall component 102 in a prismatic electrochemical cell 108, it can be advantageous if the wall component 102 is at least approximately rectangular in shape in a cross-section taken parallel to its main plane of extension.

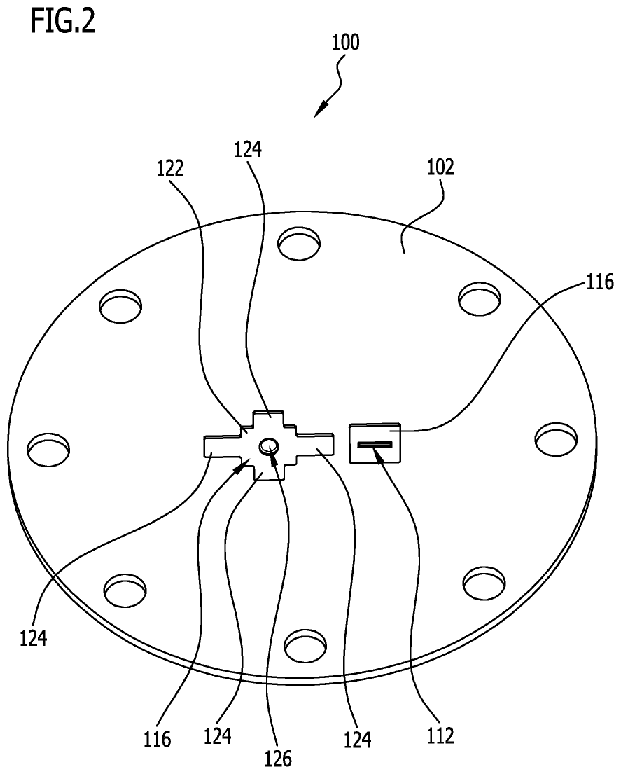

With regard to the further description of the wall component 102 shown in FIG. 1 in a state prior to assembly and the feedthrough system 100, reference is made to the following description of the embodiment of a feedthrough system 100 shown in FIGS. 2 to 5.

The further embodiment of a feedthrough system 100 shown in FIGS. 2 to 5 differs in its construction and function from the embodiment shown in FIG. 1 essentially in that the wall component 102 is at least approximately circular in a cross-section taken parallel to its main direction of extension.

In the present case, the feedthrough opening 112 is at least approximately slot-shaped and/or surrounded by a recessed region 116 of the wall component 102 in which the wall component 102 has a reduced thickness. In the present case, the recessed region 116 around the feedthrough opening 112 forms a receiving recess 136 of the wall component 102.

The receiving recess 136 is preferably formed by stamping and/or milling the wall component 102.

For example, the thickness of the wall component 102 in the region of the receiving recess 136 is less by approximately 10% or more, in particular approximately 20% or more, than the average thickness of the wall component 102 in regions adjacent thereto.

The thickness of the wall component 102 in the region of the receiving recess 136 is preferably less by approximately 90% or less, in particular approximately 80% or less, than the average thickness of the wall component 102 in regions adjacent thereto.

The thickness of the wall component 102 is preferably defined perpendicularly to its main plane of extension.

It can be advantageous if the feedthrough opening 112 is arranged centrally and/or centrically in the receiving recess 136.

As mentioned in connection with FIG. 1, a line 115 is guided through the feedthrough opening 112, in particular in such a way that the line 115 is guided through the feedthrough opening 112 from an environment of the electrochemical cell 108 into the interior.

In the present case, the line 115 is designed as a cable 114 which, for example, forms a component of a sensor device 120. The cable 114 is, for example, a ribbon cable. Alternatively, a round cable can also be used as cable 114.

The sensor device 120 is preferably used for monitoring a pressure and/or a temperature in the interior of the electrochemical cell 108. In this way, for example a thermal event can be detected in a timely manner and, in particular, prevented.

According to alternative embodiments, the line 115 can be a fluid line.

As an alternative to the formation of the line 115 as a cable 114, it can be provided that the line 115 is a signal conductor, for example in the form of a pin or a screw.

A line 115 in the form of a signal conductor, for example a pin or a screw, can be provided in addition to the cable 114 (not shown).

It can be advantageous if the wall component 102 has a further recessed region 116 which receives a sensor element 118. With regard to the thickness and design of the further recessed region, reference is made to the statements regarding the receiving recess 136.

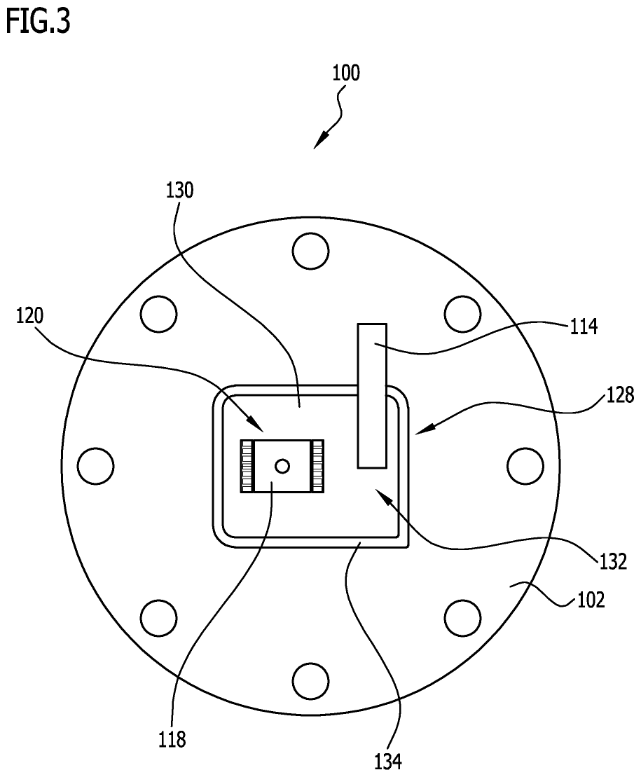

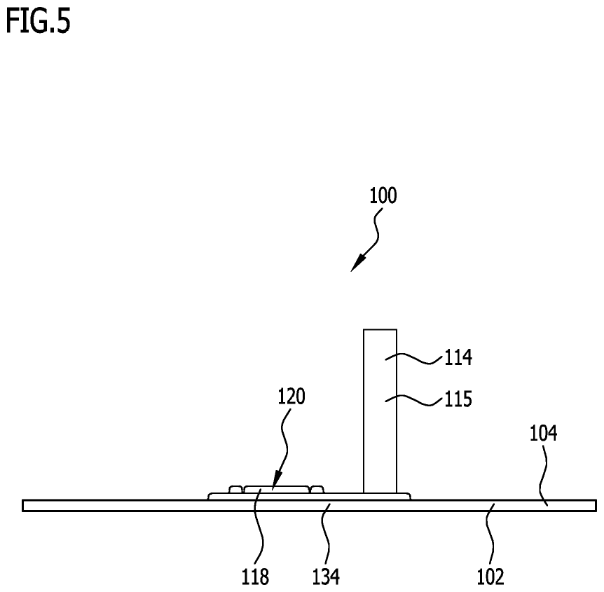

The sensor element 118 forms, for example, a component of the sensor device 120 (cf. in particular FIGS. 3 and 5).

According to a preferred embodiment, a pressure sensor and/or a temperature sensor is used as the sensor element 118.

The further recessed region 116, which in particular receives the sensor element 118, comprises, for example, an at least approximately cuboidal central region 122 and extension portions 124 adjoining it, which form a cross shape, for example.

A sensor opening 126, for example, is arranged at least approximately centrally in the central region 122 of the further recessed region 116. The sensor opening 126 serves in particular to connect the sensor element 118 to the interior of the electrochemical cell 108.

To fix the cable 114 and/or the sensor element 118 on the wall component 102, the feedthrough system 100 preferably comprises a fastening device 128.

According to the embodiment shown in FIGS. 2 to 5, the fastening device 128 comprises a sealing element 130 which surrounds the cable 114 in a connection region 132 and/or seals a volume between edge regions of the feedthrough opening 112 and the cable 114 in a fluid-tight manner.

In the present case, the sealing element 130 of the fastening device 128 also surrounds the sensor element 118 in addition to the cable 114 and/or fills a volume formed between the sensor element 118 and the cable 114 in the connecting region 132 in a fluid-tight manner.

It can be advantageous if the fastening device 128 has one or more, in the present case one, frame element(s) 134, surrounding and/or delimiting the connection region 132, for example on an outer side facing away from the interior of the electrochemical cell 108.

In the present case, the frame element 134 is at least approximately cuboidal in shape in a cross-section taken parallel to a main plane of extension of the wall component 102.

In alternative embodiments, for example when the feedthrough opening 112 is at least approximately circular, it can be provided that the frame element 134 is at least approximately oval, in particular circular, in a cross-section taken parallel to the main plane of extension of the wall component 102.

For example, the frame element 134 is a sealing bead and/or dispenser bead.

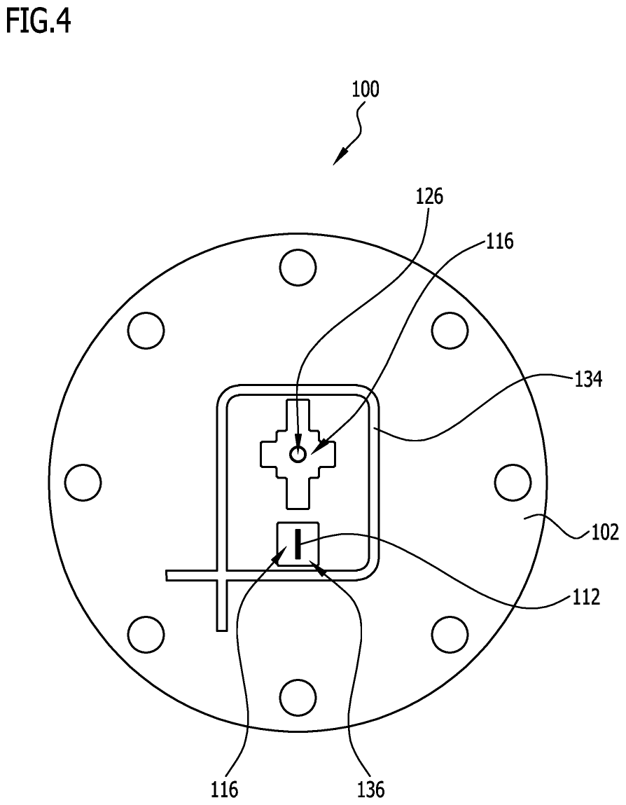

As can be seen in particular in FIG. 4, it can be advantageous if a material in the form of a pasty mass is applied directly to the wall component 102 in order to produce the feedthrough system 100 for forming the frame element 134. The material is then cured, particularly by drying and/or cross-linking, forming the frame element 134.

The frame element 134 is for example cord-shaped.

To form a closed and/or gapless frame element 134, it can be advantageous if an application outside the desired shape of the resulting frame element 134 is started and/or ended and corresponding overhangs are subsequently removed. In this way, gaps in the frame element 134 can be avoided.

A height of the frame element 134 in a direction perpendicular to the main plane of extension of the wall component 102 is preferably at least about 5% of an average thickness of the wall component 102.

It can be advantageous if the frame element 134 comprises a polymer material or is formed therefrom.

Preferred polymer materials are thermosetting polymer materials, thermoplastic polymer materials, elastomeric polymer materials, or mixtures thereof.

For example, the frame element 134 comprises one or more of the following polymer materials or is formed therefrom:

polyolefin, in particular polypropylene and/or polyethylene, polyester, in particular polyethylene terephthalate and/or polybutylene terephthalate, polyamide, polyimide, copolyamide, polyamide elastomer, polyethers, in particular epoxy resins, polyurethane, polyurethane acrylate, polyvinyl chloride, polystyrene, polymethyl methacrylate, acrylic butadiene styrene, synthetic rubber, in particular ethylene propylene diene rubber, polycarbonate, polyether sulfone, polyoxymethylene, polyether ether ketone, polytetrafluoroethylene, silicone, in particular silicone rubber and/or silicone-based elastomer.

For example, one or more hot melt materials are used for the material of the frame element 134.

As an alternative to embodiments in which the frame element 134 is designed as a separate element, it can be provided that the frame element 134 is formed by one or more raised parts in a base body of the wall component 102, which are made for example by stamping into the base body of the wall component 102 (not shown).

It can be advantageous if a volume surrounded by the frame element 134 is filled with a potting material, for example after drying and/or curing the material of the frame element 134 to form the frame element 134. In particular, the sealing element 130 is formed in this way.

In the present case, both a region which is arranged adjacent to the feedthrough opening 112 and a region which is arranged adjacent to the sensor opening 126 are enclosed by the frame element 134. Thus, the sensor element 118 and the cable 114 can be fixed in a common connecting region 132 on the wall component 102.

After the production of the frame element 134, the cable 114 is preferably guided through the feedthrough opening 112 and/or the sensor element 118 is inserted into the further recessed region 116 of the wall component 102 and/or is positioned on the sensor opening 126.

Subsequently, the potting material is preferably filled, for example poured, into the region surrounded and/or delimited by the frame element 134. Upon drying and/or curing of the potting material, the sealing element 130 is preferably formed, thereby fixing the cable 114 to the wall member 102 in a fluid-tight manner in the connection region 132.

For example, approximately 0.8 g of potting material or more and/or approximately 1.2 g or less potting material is used to form the sealing element 130.

The potting material is, for example, a resin material, for example an epoxy resin material, a phenolic resin material, an aminoplast material, a polyurethane material, a silicone material, a polyester resin material, an ABS resin material, or mixtures thereof.

It can be provided that the potting material comprises a glass material or is formed therefrom.

As a result of the casting, the cable 114 and/or the sensor element 118 can be fixed pressure-tight, for example up to an internal pressure in the electrochemical cell 108 of about 10 bar.

The sealing element 130 is preferably chemically resistant and/or temperature-resistant, due to the potting material. For example, the fastening device 128 is resistant in a temperature range of from about −20° C. to about 80° C., in particular from about −30° C. to about 100° C.

It can be provided that the potting material comprises one or more fillers. The one or more fillers are preferably selected from one or more of the following: inorganic fillers, in particular silicon oxide, carbonate, carbide, in particular silicon carbide, nitride, in particular metal nitride, metal oxide.

It can be advantageous if the material of the sealing element 130 has a hardness in a range of from approximately 40 Shore D to approximately 100 Shore D.

A glass transition temperature of the potting material is, for example, about 90° C. or more.

The sensor element 118 and the cable 114 are preferably completely encapsulated and/or cast. In particular, no potting material passes through the sensor opening 126 and/or blocks the sensor opening 126.

It can be favorable if the sensor element 118 and/or the cable 114 are fixed on and/or relative to the wall component 102 in a two-stage casting process.

For example, a fixing material in a flowable state is poured and/or filled into the connection region 132. An amount of the fixing material is here selected such that the cable 114 and the sensor element 118 are just fixed relative to the wall component 102.

Preferably, an amount of fixing material is used such that the cable 114 and an edge of the feedthrough opening 112 are just continuously connected to one another by the fixing material.

For example, the cable 114 is encapsulated circumferentially around the feedthrough opening 112 with the fixing material.

For example, an amount of fixing material is used such that the sensor element 118 and an edge of the sensor opening 126 are just continuously connected to one another by the fixing material.

For example, the sensor element 118 is encapsulated circumferentially around the sensor opening 126 with the fixing material.

Subsequently, the fixing material is partially or completely dried and/or cured, in particular until it is no longer flowable.

For example, the fixing material is dried and/or cured until it has a viscosity of about 10¹⁰ mPa·s or more at 25° C.

After a partial or complete drying and/or curing of the fixing material, a potting filler material in a flowable state is preferably filled and/or poured into the connection region 132 until this region is completely filled.

The potting filler material is in particular dried and/or cured.

In embodiments in which the fixing material has not yet been completely dried and/or cured before the pouring-in and/or filling of the potting filler material, the fixing material is here also completely dried and/or cured.

It can be advantageous if the fixing material and the potting filler material are chemically and/or physically identical.

Alternatively, it can be provided that the fixing material and the potting filler material are chemically and/or physically different from one another.

The fixing material and the potting filler material are preferably materials that are chemically and/or physically compatible with one another.

It can be advantageous if the fixing material and/or the potting filling material comprise one of the materials described in connection with the potting material or are formed therefrom.

The fixing material and the potting filler material can each form parts of the potting material.

For a permanent connection between the cable 114 and the sealing element 130, it can be advantageous if the cable 114 comprises a sheathing and/or a coating. The sheathing and/or coating is preferably made of a polymer material which is chemically and/or physically compatible with the potting material.

The sheathing and/or coating preferably forms an adhesion promoter structure.

Preferably, the potting material is selected such that a drop of water on a surface of the material encloses a contact angle with the surface of 90° or more. A creeping of water and/or electrolyte can thus be reduced or avoided.

In particular for optimized chemical resistance, it can be advantageous if the sealing element 130 has a protective coating. The protective coating preferably comprises an oxide or a parylene material or is formed from an oxide or a parylene material.

The material of the protective coating is applied, for example, to outer surfaces of the sealing element 130.

In particular for improving an adhesion of the sealing element 130 to the wall component 102, it can be advantageous if the wall component 102 has a partial or complete coating with an adhesion promoter.

Additionally or alternatively, the line 115 in the form of the cable 114 and/or the sensor element 118 can partially or completely have a coating with an adhesion promoter.

In particular, the adhesion promoter(s) form adhesion promoter structures.

Additionally or alternatively, the wall component 102 may be cleaned prior to pouring the potting material, for example by plasma cleaning and/or by cleaning with isopropanol.

Depending on the material of the conduit 115 and/or sensor element 118, it may also be advantageous for these elements to be cleaned before the potting material is poured, for example by plasma cleaning and/or by cleaning with isopropanol.

In addition, an increase in the surface roughness of the line 115 and/or non-sensitive regions of the sensor element can be carried out in regions in which these are in contact with the sealing element 130, to improve the adhesion.

In particular to form an improved adhesion of the sealing element 130 to an outer surface of the wall component 102 in the connection region 132, it can be advantageous if the wall component 102 comprises one or more (further) adhesion promoter structures in the connection region 132 (not shown).

One or more adhesion promoter structures are preferably formed by one or more recesses and/or grooves and/or corrugations in the wall component 102.

The one or more adhesion promoter structures are formed, for example, by laser treatment and/or by stamping the wall component 102.

For example, one or more, in particular regularly configured, grooves and/or pocket-shaped recesses are introduced into the wall component 102 into a region which is in contact with the sealing element 130.

Additionally or alternatively, it can be provided that stamped contours are made in the wall component 102.

In addition or alternatively, webs can be pressed down subsequently, for example by stamping. For example, T-shaped recesses can be formed in this way.

Additionally or alternatively, it can be provided for the surface of the wall component 102 to be roughened in the connection region, for example by sandblasting.

In addition or as an alternative to fixing in a potting process, the cable 114 and the wall component 112 can be welded to one another (not shown in detail).

According to another preferred embodiment, it can be provided that a sealing element 130 is formed by injecting an injection molding material into the connection region 132 (not shown in a drawing).

Alternatively or additionally, it can be provided that the cable 114 is fixed to the wall component 102 by hot caulking.

Additionally or alternatively, it can be provided that, in addition or as an alternative to the cable 114, a line 115 in the form of a signal conductor, for example a pin or a screw, is introduced into the potting material and/or is hot-caulked (not shown).

It can be provided that a screw or a rivet element is introduced into the potting material. Alternatively, the screw can also be screwed into the potting material and optionally subsequently overmolded again.

It can be provided that the feedthrough system 100 comprises further functional elements or forms a component of further functional elements (not shown).

For example, the sealing element 130 forms a burst element or comprises such an element. The burst element comprises, for example, a material weak point which breaks when a critical temperature and/or a critical pressure in the interior of the electrochemical cell 108 is exceeded, or is formed by such a weak point.

For example, a region of the sealing element 130 is made thinner, so that this region forms a material weak point.

It can be provided that a burst membrane is cast or welded into the potting material, which breaks and/or tears when a critical temperature and/or a critical pressure in the interior of the electrochemical cell 108 is exceeded.

Additionally or alternatively, it can be provided that the feedthrough system comprises or forms a fuse, which preferably melts when a critical current is exceeded.

It can be advantageous if the cable 114 is destroyed or damaged when the burst element is broken and/or the fuse is tripped, so that a flow, for example an information flow of the sensor device 120, is interrupted.

It can be favorable if an electrolyte filling opening is integrated into the feedthrough system 100 and, for example, the potting material is cast around the electrolyte filling opening.

Additionally or alternatively, it can be provided that the feedthrough system 100 forms a component of a terminal feedthrough.

For example, both the cable 114 and a connecting conductor, which connects an electrochemical element in the form of a cell winding and a cell terminal, are poured and/or cast on the wall component 102 with the potting material (not shown).

Depending on how the cable 114 is fixed to the wall component 102, different fit types can be preferred between the cable 114 and the wall component 102.

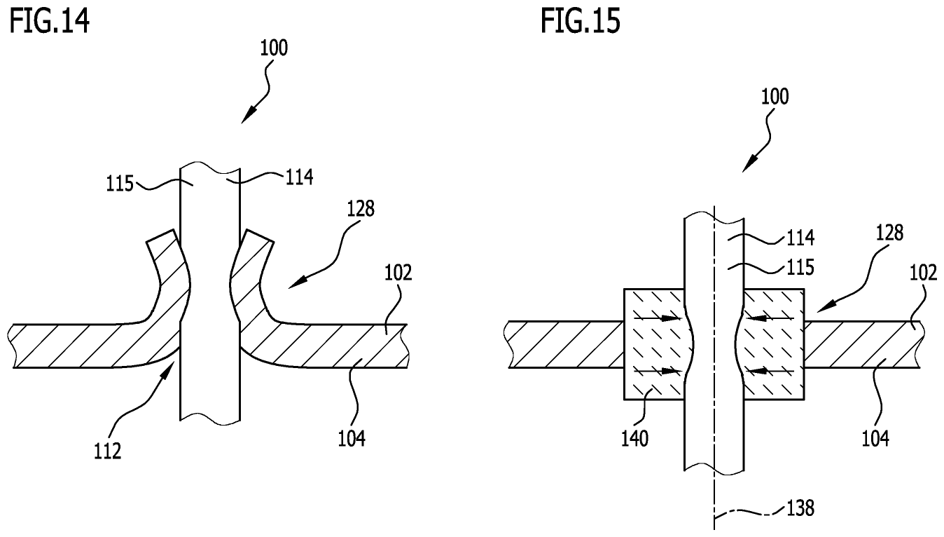

In particular when fixing by casting or by pressing (described in connection with FIG. 14), it can be advantageous if a clearance fit is formed between the wall component 102 and the cable 114 in the region of the feedthrough opening 112.

Fits are standardized, for example, in the standard ISO 286.

It can be favorable if a volume between edge regions of the wall component 102, which surround the feedthrough opening 112, and the cable 114 are filled by the sealing element 130 or by a pressing process with the wall component 102.

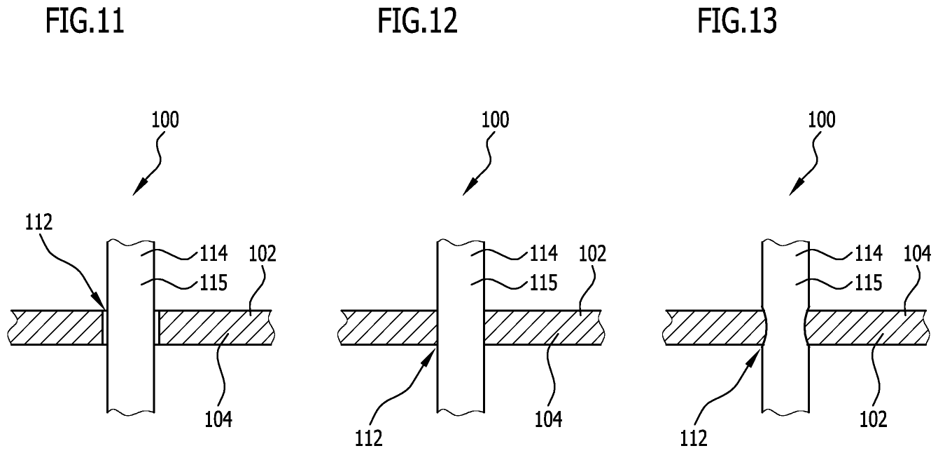

As an alternative to a clearance fit, which is again shown separately in FIG. 11, it can be provided that a transition fit (see FIG. 12) or a press fit (see FIG. 13) is formed between the wall component 102 and the cable 114.

The previously described embodiment of the feedthrough system 100 and the embodiments of feedthrough systems 100 described below can be formed with any of the types of fit shown in isolation in FIGS. 11 to 13.

The feedthrough system 100 according to the embodiment shown in FIGS. 2 to 5 comprises a cable 114 which is guided through exactly one feedthrough opening 112. A control and/or regulating device (not shown) which forms a component of the sensor device 120 is preferably arranged in the interior of the electrochemical cell 108.

Alternatively, it can be provided that the feedthrough system 100 has multiple cables 114. In embodiments in which the feedthrough system 100 has multiple cables 114, the control and/or regulating device is preferably arranged outside the interior of the electrochemical cell 108.

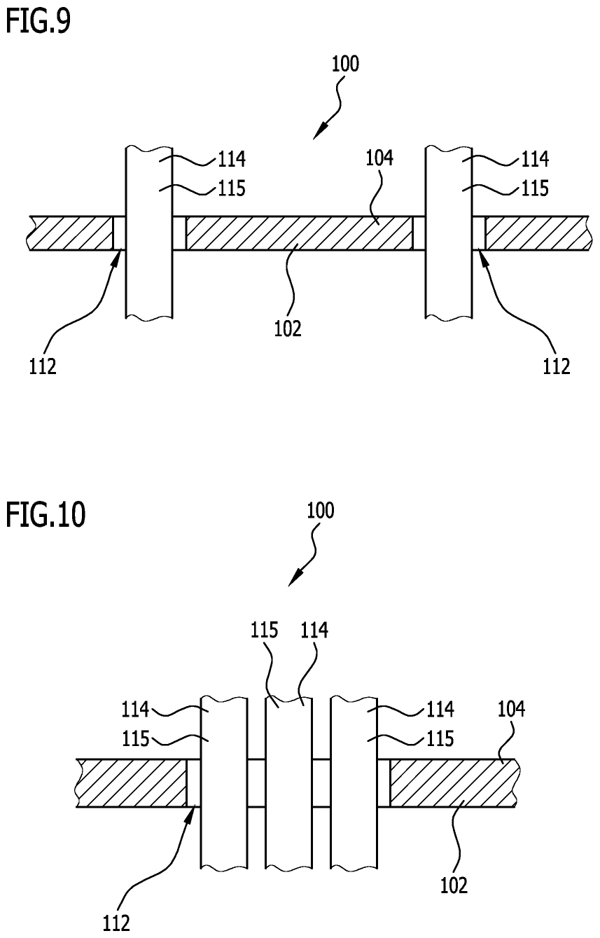

According to a preferred embodiment, exactly one cable 114 is guided through a feedthrough opening 112. This is shown schematically in FIG. 9.

According to a further alternative, it can be provided that multiple cables 114 are guided through a single feedthrough opening 112. This is shown schematically in FIG. 10.

According to a further alternative, the cable 114 can have a multipart construction, and individual cable components are connected to one another by a connecting element. This is described in more detail in connection with the embodiment of a feedthrough system 100 shown in FIG. 17.

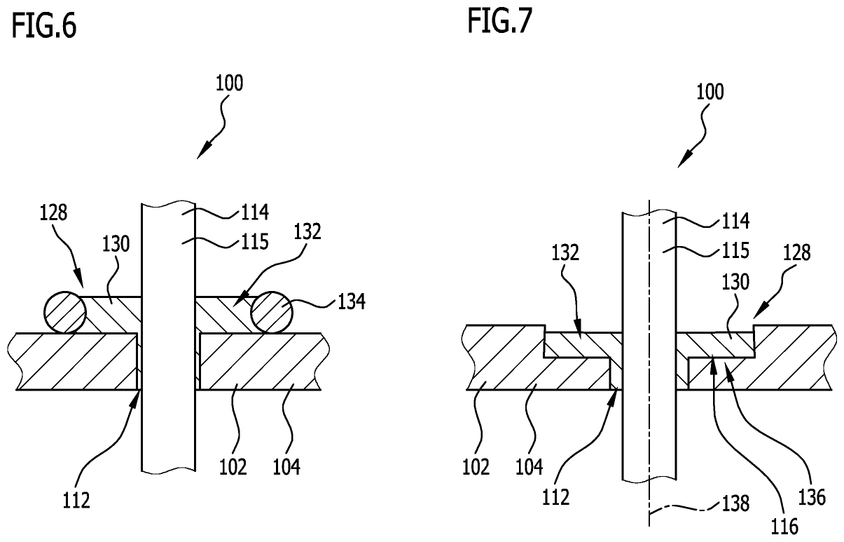

A further embodiment of a feedthrough system 100 shown in FIG. 6 differs substantially in its construction and function from the embodiment shown in FIGS. 2 to 5, in that the wall component 102 does not have a receiving recess 136.

In the present case, the frame element 134 has an at least approximately circular shape in a cross-section taken perpendicular to the main plane of extension of the wall component 102. This preferably applies equally to the frame element 134 according to the embodiment shown in FIGS. 2 to 5.

In contrast to the embodiment shown in FIGS. 2 to 5, only the cable 114 (and not the sensor element 118) is fixed to the wall component 102 in the shown connecting region 132.

Otherwise, the further embodiment of a feedthrough system 100 shown in FIG. 6 corresponds substantially in its structure and function to the embodiment shown in FIGS. 2 to 5, so that reference is made to the description thereof.

A further embodiment of a feedthrough system 100 shown in FIG. 7 differs substantially in its construction and function from the embodiment shown in FIGS. 2 to 5 in that the wall component 102 does not have a frame element 134.

Preferably, the sensor element 118 (not shown in FIG. 7) and the cable 114 are fixed in spatially separate connection regions 132 on the wall component 102.

The sealing element 130 preferably terminates substantially flat with an outer surface of the wall component 102.

Otherwise, the embodiment of a feedthrough system 100 shown in FIG. 7 corresponds in its structure and function to the embodiments in FIGS. 2 to 5, so that reference is made to the description thereof.

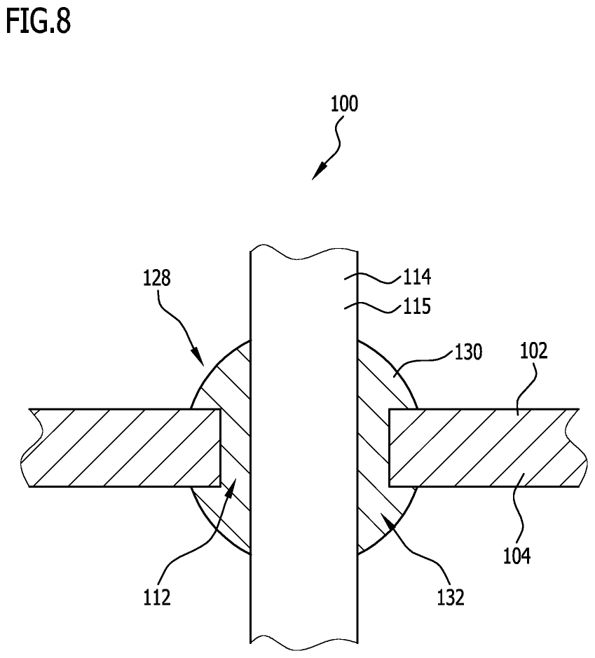

A further embodiment of a feedthrough system 100 shown in FIG. 8 differs substantially from the embodiment shown in FIGS. 2 to 5 in that no frame element 134 and no receiving recess 136 are provided; rather, the sealing element 130 is formed by pouring the potting material into the connection region 132 without further spatial delimitation.

In the present case, the sealing element 130 forms, for example, at least approximately a spherical shape or an ellipsoidal shape.

Otherwise, the further embodiment of a feedthrough system 100 shown in FIG. 8 corresponds substantially in its structure and function to the embodiment shown in FIGS. 2 to 5, so that reference is made to the description thereof.

A further embodiment of a feedthrough system 100 shown in FIG. 14 differs in its construction and function from the embodiment shown in FIGS. 2 to 5 substantially in that the cable 114 and the wall component 102 are connected to one another by pressing.

For example, the wall component 102 is deformed at edge regions which surround the feedthrough opening 112, for example by flanging.

A potting process and/or an injection molding process and/or a hot caulking are, in particular, dispensable when fixing by pressing.

Otherwise, the embodiment of a feedthrough system 100 shown in FIG. 14 corresponds substantially in its structure and function to the embodiment shown in FIGS. 2 to 5, so that reference is made to the description thereof.

A further embodiment of a feedthrough system 100 shown in FIG. 15 differs in its construction and function substantially from the embodiment shown in FIG. 14 in that the cable 114 is fixed to the wall component 112 by material shrinkage.

In the present case, the fastening device 128 comprises an insert element 140. Preferably, the insert element 140 is made of a casting material which, for example, comprises a glass material or aluminum, or is formed therefrom.

The insert element 140 preferably surrounds the cable 114 in the radial direction with respect to a central axis 138 of the cable 114.

For example, the insert element 140 shrinks in the direction of the cable 114, so that the cable is compressed by the insert element 140. The shrinkage is indicated schematically in FIG. 15 by arrows.

According to an alternative embodiment, provision can be made for the wall component 102 itself to shrink in the region of the feedthrough opening 112 so that the cable 114 is compressed directly by the wall component 102 (not shown).

Otherwise, the embodiment of a feedthrough system 100 shown in FIG. 15 corresponds substantially in its structure and function to the embodiment shown in FIG. 14 so that reference is made to the description thereof.

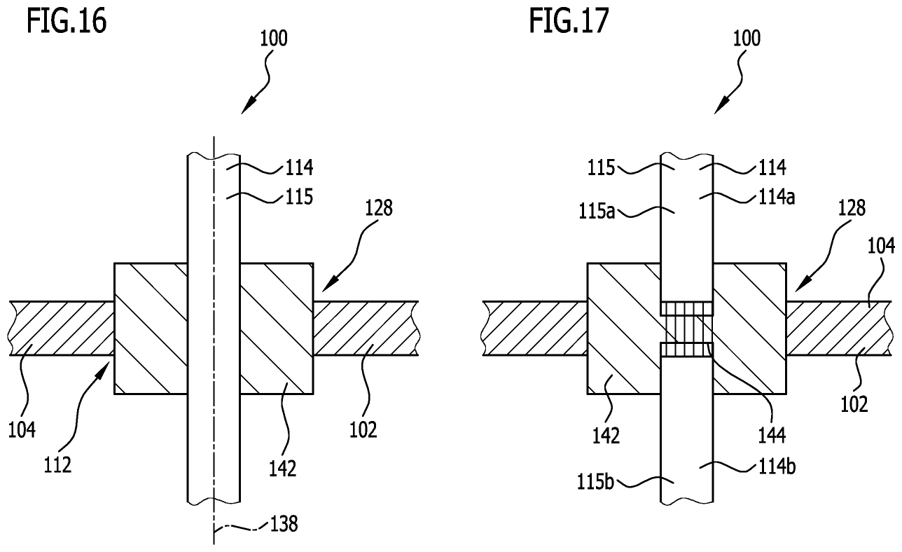

A further embodiment of a feedthrough system 100 shown in FIG. 16 differs substantially in its construction and function from the embodiment shown in FIG. 14 in that the fastening device 128 comprises a support element 142 which is arranged in the radial direction with respect to the central axis 138 of the cable 114 between the wall component 102 and the cable 114.

The supporting element 142 preferably serves to support and/or position the cable 114 in the feedthrough opening 112.

It can be advantageous if the supporting element 142 is made of an electrically insulating material.

“Electrically insulating” preferably means that the respective materials and/or elements have an electrical conductivity of less than 10⁻⁸ S/m at 25° C.

In embodiments in which the supporting element 142 is made of an electrically insulating material, the supporting element 142 is used in particular for an electrical insulation of the cable 114 relative to the wall component 102 and/or the interior of the electrochemical cell 108.

Additional elements for insulation are thus preferably dispensable.

For example, the support element 142 forms a force-locking connection with the cable 114 and/or the wall component 102.

Support elements 142 are advantageous in particular in embodiments in which the cable 114 is at least approximately round in a cross-section taken parallel to the main plane of extension of the wall component 102 and/or a transition fit is formed between the wall component 102 and the cable 114.

It can be advantageous if the support element 142 comprises a polymer material or is formed therefrom.

For example, the support element 142 is an injection-molded component or a potting element.

For example, the supporting element 142 has an at least approximately hollow cylindrical shape.

In addition or as an alternative to one or more separate support elements 142, it can be provided that the wall component 102 has one or more raised parts in a direction running perpendicular to the main plane of extension of the wall component 102. The one or more raised parts preferably each form a support element 142. This design of the support elements 142 can be advantageous in particular for a pressure sensor.

Preferably, the one or more raised parts form a positive-locking connection with the cable 114.

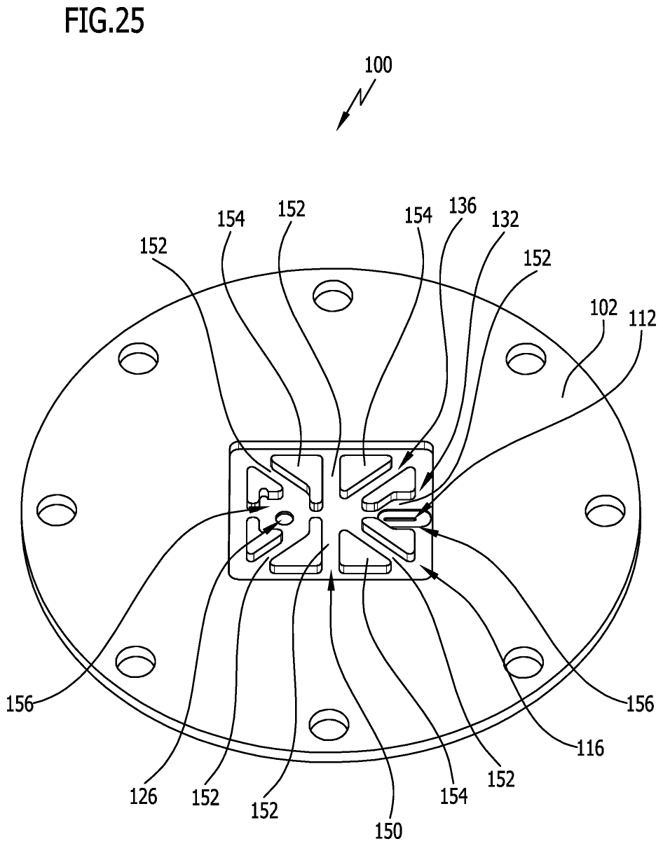

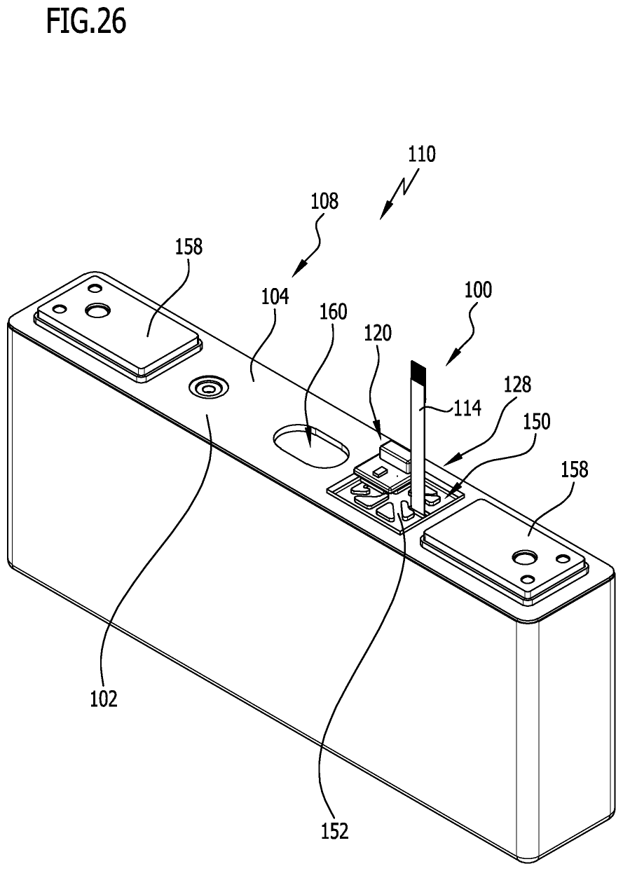

Additionally or alternatively to raised parts which each form a support element 142, it can be provided that the wall component 102 comprises one or more raised parts 154 as a component of a stabilizing element 150. This is described in connection with FIGS. 25 to 28.

It can be provided that, in addition or as an alternative to the cable 114, a rivet element is inserted into the feedthrough opening 112 or a further opening together with a support element 142 (not shown). The support element 142 is compressed in a fluid-tight manner in particular by a riveting process.

Otherwise, the embodiment of a feedthrough system 100 shown in FIG. 16 corresponds substantially in its structure and function to the embodiment shown in FIG. 14 so that reference is made to the description thereof.

A further embodiment of a feedthrough system 100 shown in FIG. 17 differs substantially in its construction and function from the embodiment shown in FIG. 16 in that the cable 114 has a multipart construction and comprises a first cable component 114a and a second cable component 114b which are electrically conductively connected to one another by a connecting element 144.

The first cable component 114a forms a first line component 115a. The second cable component 114b forms a second line component 115b.

In embodiments in which the line 115 is a fluid line, the connecting element 114 fluidly connects the first line component 115a to the second line component 115b (not shown).

All embodiments of a feedthrough system 100 described above or below with one-piece cables 114 can alternatively also be realized with multipart cables 114a, 114b.

The first cable component 114a, the second cable component 114b preferably have the same main direction of extension.

Otherwise, the embodiment of a feedthrough system 100 shown in FIG. 17 corresponds substantially in its structure and function to the embodiment shown in FIG. 16 so that reference is made to the description thereof.

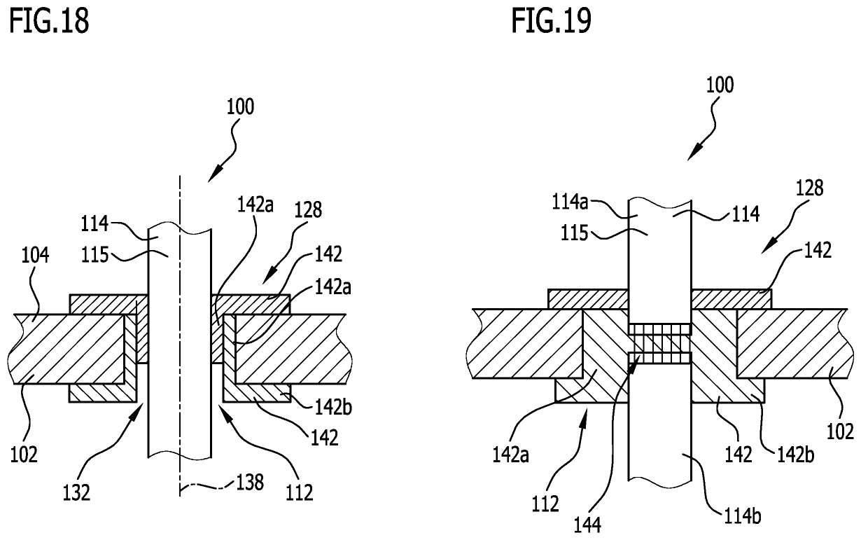

A further embodiment of a feedthrough system 100 illustrated in FIG. 18 differs substantially in its construction and function from the embodiment shown in FIG. 16 in that the fastening device 128 comprises two support elements 142 which are arranged in interlocking fashion in the feedthrough opening 112.

In the present case, the two support elements 142 each have a hollow cylindrical section 142a and a disk-shaped section 142b. In the present case, the disk-shaped section 142b in each case is arranged adjacent to the corresponding hollow cylindrical section 142a and/or is arranged at a free end thereof.

In the present case, the support elements 142 are arranged such that the disk-shaped sections 142b stand out beyond the wall component 102 on opposite sides of the wall component 102 in the axial direction with respect to the central axis 138 of the cable 114.

In the present case, the hollow cylindrical sections 142a are arranged within the feedthrough opening 112 and/or receive the cable 114.

A position of the cable 114 relative to the wall component 102 can be secured and/or defined by the support elements 142.

For example, a non-positive fit of the cable 114 with the support elements 142 is formed by the two support elements 142 and/or between the two support elements 142.

Otherwise, the embodiment of a feedthrough system 100 shown in FIG. 18 corresponds substantially in its structure and function to the embodiment shown in FIG. 16 so that reference is made to the description thereof.

A further embodiment of a feedthrough system 100 shown in FIG. 19 differs substantially in its construction and function from the embodiment shown in FIG. 17 in that the fastening device 128 has two support elements 142 which are arranged one behind the other in the axial direction with respect to the central axis 138 of the cable 114.

It can be advantageous if one of the support elements 142 has a hollow cylindrical section 142a and an at least approximately disk-shaped section 142b.

A further support element 142 differing therefrom is preferably formed at least approximately disk-shaped as a whole.

Otherwise, the embodiment of a feedthrough system 100 shown in FIG. 19 corresponds substantially in its structure and function to the embodiment shown in FIG. 17, so that reference is made to the description thereof.

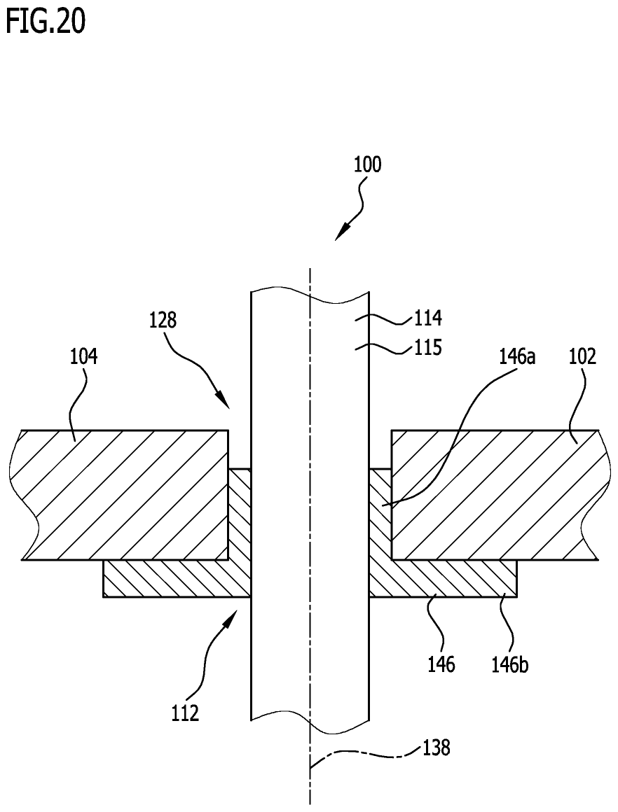

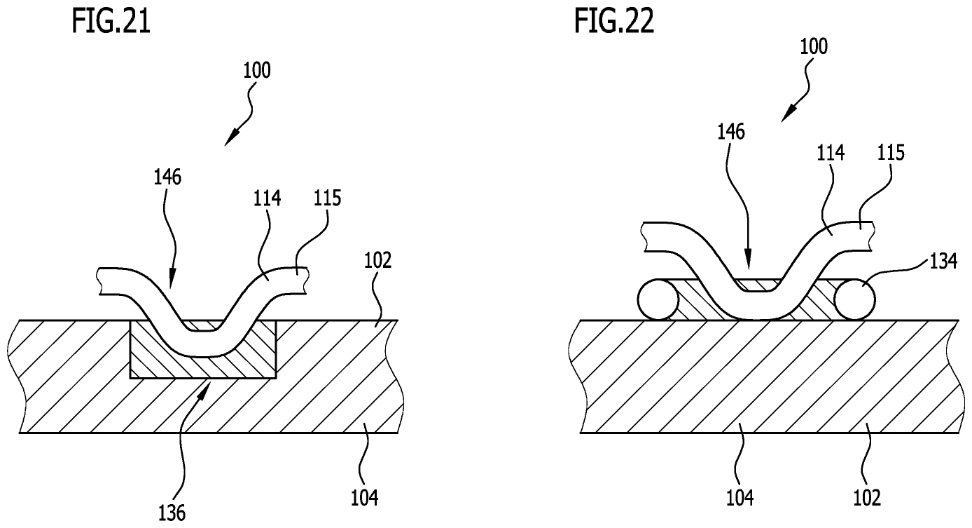

A further embodiment of a feedthrough system 100 shown in FIG. 20 differs substantially in its construction and function from the embodiment shown in FIG. 18 in that the fastening device 128 has a relief element 146.

The relief element 146 serves in particular for strain relief and/or forms a strain relief for the cable 114.

The relief element 146 preferably comprises a hollow cylindrical section 146a which is arranged between the wall component 102 and the cable 114, in the radial direction with respect to the central axis 138 of the cable 114.

The disk-shaped section 146b of the relief element 146 is arranged, for example, on a side of the wall component 102 facing the interior of the electrochemical cell 108.

It can be provided that a further relief element 146 is provided, which is introduced and/or inserted in particular from a side of the wall component 102 facing away from the interior of the electrochemical cell 108 into the feedthrough opening 112 (not shown in the drawing).

It can be provided that the relief element 146 is cast and/or injection-molded on the wall component 102.

Alternatively or additionally, the cable 114 can be cast and/or molded onto the relief element 146.

Additionally or alternatively, the relief element 146 is fixed by clamping in the feedthrough opening 112 and/or on the wall component 102.

The relief elements 146 preferably also form support elements 142.

Otherwise, the embodiment of a feedthrough system 100 shown in FIG. 20 corresponds substantially in its structure and function to the embodiment shown in FIG. 18, so that reference is made to the description thereof.

A further embodiment of a feedthrough system 100, which is not shown in the drawing as a whole in FIG. 21, differs substantially from the embodiment shown in FIG. 20 in its construction and function in that the relief element 146 is formed by casting and/or molding a part of the cable 114 into a potting material on an outer side of the wall component 102 facing away from the interior of the electrochemical cell 108.

With regard to the material selection for the potting material, reference is made to the statements in connection with the embodiment shown in FIGS. 2 to 5.

In the present case, the potting material is cast into a receiving recess 136 and/or the cable 114 is molded thereon.

For example, the cable 114 is pressed into the potting material and/or positioned therein before drying and/or curing the potting material, so that after the drying and/or curing of the potting material the cable 114 is fixed relative to the wall component 102.

In the present case, the receiving recess 136 is designed as a receiving recess 136 that is spatially different from the receiving recess 136 in the connecting region 132.

Alternatively, it can be provided that the relief element 146 is designed as part of the connection region 132 (not shown).

Otherwise, the embodiment of a feedthrough system 100 shown in FIG. 21 corresponds substantially in its structure and function to the embodiment shown in FIG. 20 so that reference is made to the description thereof.

A further embodiment of a feedthrough system 100 not shown in the drawing as a whole, shown in FIG. 22, differs substantially from the embodiment shown in FIG. 21 with respect to its structure and function in that the relief element is formed by casting and/or molding onto the cable 114 in a region surrounded by a frame element 134.

With regard to the material selection of the frame element 134, reference is made to the description of the frame element 134 which surrounds the connection region 132.

In the present case, the frame element 134 which forms part of the relief element 146, is formed separately from the frame element 134 which forms part of the fastening device 128.

Alternatively, it can be provided that the frame elements 134 are identical and the relief element 146 forms a part of the connection region 132.

Otherwise, the embodiment of a feedthrough system 100 shown in FIG. 22 corresponds substantially in its structure and function to the embodiment shown in FIG. 21 so that reference is made to the description thereof.

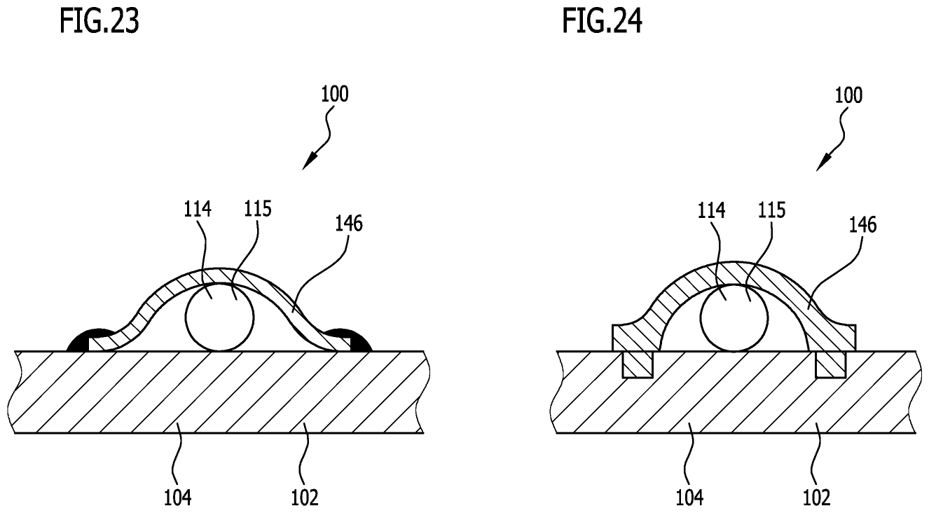

A further embodiment of a feedthrough system 100, which is not shown in the drawing as a whole in FIG. 23, differs from the embodiment shown in FIG. 21 in its construction and function substantially in that the relief element 146 is a separate component which at least partially surrounds the cable 114 on an outer side of the wall component 102 facing away from the interior of the electrochemical cell 108 and/or fixes it in a positive-locking and/or force-locking manner on the wall component 102.

It can be advantageous if the stress relief element 146 is fixed to the wall component at its free ends by a material bond, for example by gluing and/or welding.

According to a further embodiment, it can be provided that the relief element 146 is formed by a sealing bead which extends over the cable 114, transversely to a main direction of extension of the cable 114. In this way, a wet-chemical fixing of the cable 114 can take place. The relief element 146 is preferably fixed on both sides next to the cable 114 on the wall component 102 (not shown).

To produce the relief element 146, for example the sealing bead in the not yet dried state is pressed against the cable, or the cable 114 is pressed against the sealing bead.

Otherwise, the embodiment of a feedthrough system shown in FIG. 23 corresponds in its structure and function to the embodiment of a feedthrough system shown in FIG. 21 so that reference is made to the description thereof.

A further embodiment of a feedthrough system 100, which is not shown in the drawing as a whole in FIG. 24, differs substantially from the embodiment shown in FIG. 23 in its construction and function in that the relief element is fixed on the wall component in a force-locking and/or positive-locking manner, for example in a clip connection.

Otherwise, the embodiment of a feedthrough system 100 shown in FIG. 24 corresponds in its structure and function to the embodiment shown in FIG. 23 so that reference is made to the description thereof.

The relief elements 146 described in connection with FIGS. 21 to 24 may be used in combination with any of the embodiments described above.

A further embodiment of a feedthrough system 100 shown in FIG. 25 differs substantially in its construction and function from the embodiment shown in FIGS. 2 to 5 in that the wall component 102 has a stabilizing element 150.

Alternatively to the provision that the wall component 102 has a single stabilizing element 150, it can be provided that the wall component 102 has multiple stabilizing elements 150 (not shown).

The stabilizing element 150 is preferably used to stiffen the recessed region 116 and/or to provide an optimized adhesion of a potting material to the wall component 102.

For example, the stabilizing element 150 forms the recessed region 116.

In the present case, both the feedthrough opening 112, through which the cable 114 is guided, and the sensor opening 126 for connecting the sensor element 118 to an interior of the electrochemical cell 100 are surrounded by a common recessed region 116.

In the present case, the recessed region 116 is at least approximately rectangular, for example at least approximately square, in a cross-section taken parallel to the main plane of extension of the wall component 102.

The stabilizing element 150 preferably comprises a metallic material, for example aluminum, or is formed therefrom.

In the present case, the stabilizing element 150 is formed integrally with a base body of the wall component 102, for example made from the same portion of a sheet.

Alternatively, it can be provided that the stabilizing element 150 is produced separately from the base body of the wall component 102. The stabilizing element 150 is in particular connected in a positive-locking and/or force-locking and/or materially bonded manner to the base body of the wall component 102.

In the present case, the stabilizing element 150 has multiple recesses in the form of reprocessed regions 152, which are formed, for example, by stamping and/or milling.

Multiple raised parts 154 extend between the reprocessed regions 152 in the present case.

An average thickness of the stabilizing element 150 in the region of the raised parts 154 preferably substantially corresponds approximately to an average thickness of the wall component 102 outside the recessed region 116 of the wall component 102.

It may be favorable if the thickness of the stabilizing element 150 in the region of the reprocessed regions 152 is approximately 80% or less, in particular approximately 60% or less, for example approximately 40% or less, of an average thickness of the wall component 102 outside the recessed region 116.

Preferably, the thickness of the stabilizing element 150 in the region of the reprocessed regions 152 is approximately 1% or more, in particular approximately 2% or more, for example approximately 5% or more, of the average thickness of the wall component 102 outside the recessed region 116.

Preferably, the raised parts 154 are completely surrounded by the reprocessed regions 152 in directions extending parallel to the main plane of extension of the wall component 102.

It can be favorable if the raised parts 154 are at least approximately triangular in a cross-section taken parallel to the main plane of extension of the wall component 102.

For example, the raised parts 154 form stiffening regions that are surrounded by potting material in an assembled state.

Preferably, the stabilizing element 150 as a whole forms a receptacle and/or a basin for the potting material.

It can be advantageous if at least a part of the reprocessed regions 152 is made web-shaped. For example, several reprocessed regions 152 extend along radial directions with respect to a central axis of the stabilizing element 150.

In addition or as an alternative to web-shaped reprocessed regions 152, it can be provided that the feedthrough opening 112 and/or the sensor opening 126 are surrounded by, for example, basin-shaped bulges 156. In the present case, the bulges 156 are reworked regions 152.

For example, the bulges 156 are formed by arched and/or curved walls of the raised parts 154, which surround the respective bulge 156.

In the present case, potting material guide channels are formed by the raised parts 154 and the reprocessed regions 152, said channels serving in particular to uniformly distribute the potting material during the filling of a flowable potting material compound.

Preferably, a deformation of the wall component 102 during filling of the connection region with potting material can be prevented or minimized by the stabilizing element 150.

Otherwise, the embodiment of a feedthrough system 100 shown in FIG. 25 corresponds substantially in its structure and function to the embodiments shown in FIGS. 2 to 5 so that reference is made to the description thereof.

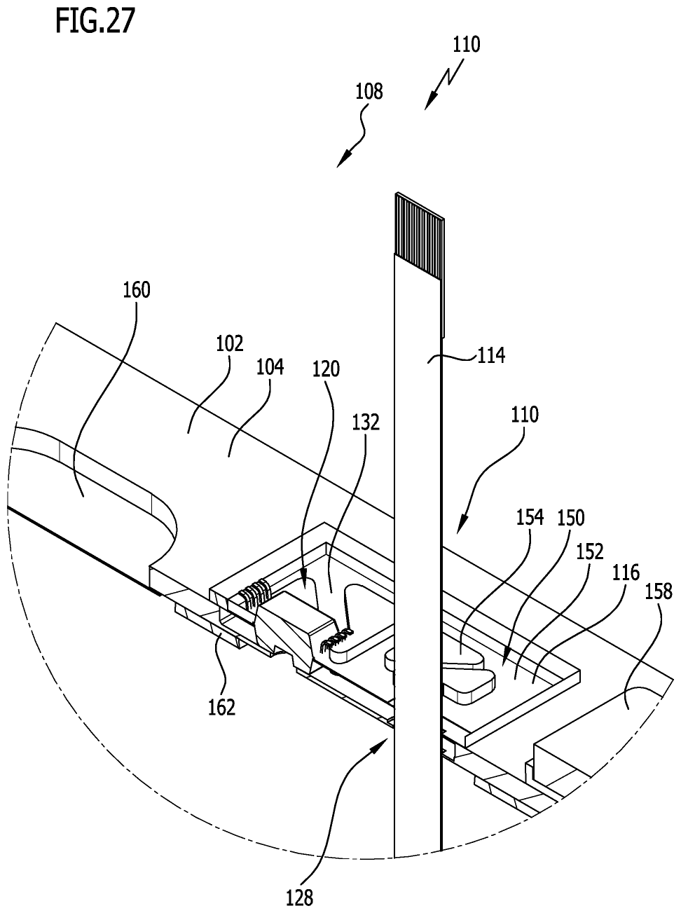

FIGS. 26 and 27 show an electrochemical cell 108 of an electrochemical system 110. In the present case, the electrochemical cell 108 comprises a housing 106 which comprises a first housing component in the form of a cup-shaped housing element and a second housing component in the form of a cover element 104.

In the present case, the electrochemical cell 108 comprises a feedthrough system 100.

In its construction and function, the feedthrough system 100 differs substantially from the embodiment shown in FIG. 25 in that the wall component 102 is at least approximately rectangular in a cross-section taken perpendicular to the main plane of extension.

In the present case, the wall component 102 is formed by the cover element 108.

In the present case, the stabilization element 150 is arranged between a cell terminal 158 and a burst element 160 (schematically indicated), for example a predetermined breaking point, of the electrochemical cell 108.

As can be seen in particular in FIG. 27, an insulation element 162 is preferably arranged on a side of the cover element 104 facing an interior of the electrochemical cell 108.

Otherwise, the embodiment of a feedthrough system shown in FIGS. 26 and 27 corresponds substantially in its structure and function to the embodiment shown in FIG. 25, so that reference is made to the description thereof.

According to a particularly preferred embodiment, the feedthrough system 100 comprises a single line 115 which forms a clearance fit with the wall component 102. One or more adhesion promoter structures are preferably arranged and/or formed on the wall component 102, as a result of which, in particular, the potting material which is poured into the connecting region 132 has an optimized adhesion. The potting material preferably fills a volume formed by the clearance fit in the feedthrough opening 112.

The wall component 102 preferably forms the entire cover element 104 of the electrochemical cell 108.

According to a further particularly preferred embodiment, the feedthrough system comprises a single line 115 which forms a clearance fit with the wall component 102. A volume formed by the clearance fit in the region of the feedthrough opening 112 is preferably filled by one or more support elements 142, which are preferably fixed by pressing. For example, the one or more support elements 142 are clamped in the wall component 102 and/or the respective line 115 is clamped in the one or more support elements 142.

The one or more support elements 142 preferably form one or more relief elements 146.

The wall component 102 preferably forms the entire cover element 104 of the electrochemical cell 108.

By means of the described embodiments of the feedthrough system 100, pressure-tight, temperature-stable and/or chemically resistant feedthroughs of the one or more lines 115 can preferably be formed by the respective wall component 102.

A diffusion of fluid through the sealing element 130 is preferably inhibited.

1. A feedthrough system for an electrochemical system, the feedthrough system comprising:
a wall component having one or more feedthrough openings;
one or more lines that are guided through the one or more feedthrough openings; and
a fastening device which connects the one or more lines to the wall component in one or more connection regions of the feedthrough system.

2. The feedthrough system in accordance with claim 1, wherein the fastening device comprises one or more sealing elements which surround the one, or one or more, of the lines in one or more of the connection regions, in particular radially, wherein in particular the one and/or the multiple sealing elements are formed by pouring a potting material into the respective connection region or by injecting an injection molding material into the respective connection region.

3. The feedthrough system in accordance with claim 2, wherein the wall component has one or more receiving recesses which receive the potting material or the injection molding material, and/or wherein the fastening device has one or more, in particular annular, frame elements which are completely or partially filled with the potting material and/or surround and/or delimit the respective connection region.

4. The feedthrough system in accordance with claim 2, wherein the potting material comprises or is formed from a glass material or a polymer material, wherein preferably the polymer material is selected from one or more of the following materials:
an epoxy resin material;
a phenolic resin material;
an aminoplast material;
a polyurethane material;
a silicone material;
a polyester resin material; and
an ABS resin material.

5. The feedthrough system in accordance with claim 2, wherein the potting material comprises one or more fillers, the one or more fillers preferably being one or more inorganic fillers, in particular silicon oxide, carbonate, carbide, for example silicon carbide, nitride, for example metal nitride, metal oxide.

6. The feedthrough system in accordance with claim 2, wherein for the one or more sealing elements a material is selected that is formed such that a drop of water on a surface of the material encloses a contact angle of greater than 90° with the surface of the material.

7. The feedthrough system in accordance with claim 1, wherein the one, or one or more, of the lines have one or more adhesion promoter structures, for example a sheathing and/or coating, wherein in particular the respective adhesion promoter structure comprises or is formed from a polymer material which is chemically and/or physically compatible with a material of the fastening device.

8. The feedthrough system in accordance with claim 1, wherein the feedthrough system comprises one or more adhesion promoter structures which are arranged on a base body of the wall component or are formed by the wall component, wherein in particular the one or more adhesion promoter structures are formed by a surface treatment of the wall component or a coating on the base body of the wall component.

9. The feedthrough system in accordance with claim 1, wherein the fastening device has a protective coating, wherein preferably the protective coating is arranged on an outer surface of the fastening device and in particular comprises or is formed from an oxide, for example aluminum oxide, or a parylene material.

10. The feedthrough system in accordance with claim 1, wherein the one, or one or more, of the lines are mechanically compressed and/or pressed in one or more of the connection regions, in particular by deforming the wall component or by shrinkage on the wall component or by shrinkage on one or more insert elements of the fastening device.

11. The feedthrough system in accordance with claim 1, wherein the one, or one or more, of the lines have a multi-part construction, in each case a first line component being electrically and/or fluidly connected to a second line component by means of a connecting element, wherein in particular the connecting element is received by the fastening device, for example embedded in a potting material.

12. The feedthrough system in accordance with claim 1, wherein the wall component comprises one or more stabilizing elements in which the one, or one or more, of the feedthrough openings are arranged, the one or more stabilizing elements each having one or more raised parts which extend away from a base body of the respective stabilizing element, in particular between one or more reprocessed regions of the respective stabilizing element.

13. The feedthrough system in accordance with claim 12, wherein the one or more reprocessed regions are web-shaped and/or are formed by a stamping process or a milling process.

14. The feedthrough system in accordance with claim 1, wherein the fastening device comprises one or more support elements for supporting and/or positioning the one, or one or more, of the lines, the one or more support elements preferably being disk-shaped and/or sleeve-shaped.

15. The feedthrough system in accordance with claim 1, wherein the fastening device comprises one or more relief elements by means of which the one, or one or more, of the lines are fixed to one side of the wall component, for example to an outer side facing away from an interior of a housing, for example by casting, and/or in a positively-locking and/or force-locking manner, for example through a formation of a relief element as a clamp or sealing bead.

16. A method for producing a feedthrough system, in particular a feedthrough system in accordance with claim 1, the method comprising the following:
providing a wall component having one or more feedthrough openings;
guiding one or more lines through the one or more feedthrough openings; and
fixing the one or more lines on the wall component in one or more connection regions by means of a fastening device.

17. The method in accordance with claim 16, wherein the one or more lines are fixed with a fixing material relative to the wall component and/or in the one or more feedthrough openings and that, in particular after the fixing material has been partially or completely cured, a potting filler material is poured into the one or more connection regions.

18. An electrochemical cell comprising one or more feedthrough systems in accordance with claim 1, wherein in particular a wall component of at least one of the one or more feedthrough systems forms a part of a housing of the electrochemical cell surrounding an interior of the electrochemical cell.

19. The electrochemical cell in accordance with claim 18, wherein the one, or one or more, of the feedthrough systems form a component of a terminal feedthrough in the region of which a connecting conductor of the electrochemical cell is fixed to a cover element of the electrochemical cell.

20. The electrochemical cell in accordance with claim 18, wherein the one, or one or more, of the feedthrough systems comprise or form a burst element which is arranged and/or designed such that, when a critical pressure and/or a critical temperature in the interior of the electrochemical cell is exceeded, it breaks, and/or wherein the one, or one or more, of the feedthrough systems comprise or form a fuse.

21. The electrochemical cell according to claim 18, wherein the one, or one or more, of the feedthrough systems comprise or forms an electrolyte filling opening for filling and/or for removing electrolyte from the interior of the electrochemical cell.

22. An electrochemical system comprising one or more electrochemical cells in accordance with claim 18.
